(19) United States
(12) Patent Application Publication
(10) Pub. No.: US 2024/0416898 A1
(43) Pub. Date: Dec. 19, 2024

(54) COLLISION NOTIFICATION BETWEEN AUTONOMOUS VEHICLES

(71) Applicant: Volvo Car Corporation, Gothenburg (SE)

(72) Inventors: Oswaldo Perez Barrera, Gothenburg (SE); Anders Lennartsson, Gothenburg (SE)

(21) Appl. No.: 18/334,121

(22) Filed: Jun. 13, 2023

(51) Int. Cl. B60W 30/09; B60W 30/095; B60W 40/06; B60W 60/00

(52) U.S. Cl. CPC B60W 30/09; B60W 30/0956; B60W 40/06; B60W 60/0015; B60W 2554/80

(57) ABSTRACT

Various systems and methods are presented regarding utilizing technology onboard a first vehicle to reduce probability of a second vehicle being further involved in a traffic accident occurring between the first vehicle and a third vehicle. The first vehicle can transmit a notification to the second vehicle, wherein the notification can provide details regarding the collision, collision location, vehicles involved, etc. The second vehicle, operating autonomously, can self-adjust operation to avoid being involved in the accident, e.g., the first vehicle and third vehicle are in a rear-end collision, which the second vehicle can navigate to avoid. The second vehicle can, for example, self-determine whether a safe braking distance can be achieved, navigation into an adjacent lane, warn other vehicles of the collision. Accordingly, autonomous vehicles can reduce probability of pile-up collisions occurring.

### TECHNICAL FIELD

This application relates to techniques facilitating communication between two or more vehicles to mitigate probability of one or more of the vehicles from being involved in an accident.

### BACKGROUND

Traffic accidents are unfortunately commonplace on today's roads, and often a rear-end collision involving two vehicles can quickly escalate into a multiple vehicle collision, aka a “pile-up”, a multi-car collision, a multi-vehicle collision, and suchlike. Chain collisions (e.g., a chain of rear-end collisions) can result from, for example, vehicles travelling with insufficient braking distance, poor visibility, weather conditions (e.g., rain, snow, etc.), road conditions (e.g., black ice, wet road surface), turn in the road, distracted driver (e.g., texting), and suchlike.

The above-described background is merely intended to provide a contextual overview of some current issues and is not intended to be exhaustive. Other contextual information may become further apparent upon review of the following detailed description.

### SUMMARY

The following presents a summary to provide a basic understanding of one or more embodiments described herein. This summary is not intended to identify key or critical elements, or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented to facilitate a reduction in road traffic accidents by utilizing one or more systems/technologies located onboard a first vehicle to notify a second vehicle of a collision, enabling the second vehicle to pre-emptively operate to avoid the collision.

According to one or more embodiments, a system can be located on a first vehicle navigating a road. The system can comprise a memory that stores computer executable components and a processor that executes the computer executable components stored in the memory. The computer executable components can comprise an accident avoidance component configured to adjust operation of the first vehicle based on a notification received from a second vehicle, wherein the notification indicates a collision present in the road being navigated by the first vehicle. In an embodiment, the first vehicle is operating at least partially autonomously while navigating the road. In an embodiment, the collision involves the second vehicle and a third vehicle. In a further embodiment, the second vehicle was operating autonomously at the time the collision occurred. Furthermore, the notification can further comprise information regarding the third vehicle.

The computer executable components can further comprise a camera configured to generate an image of the road being navigated by the first vehicle. The computer executable components can further comprise a vehicle detection component configured to detect the third vehicle, wherein detection of the third vehicle is based at least in part on identification of the third vehicle in the image, wherein the identification is based at least in part on the third vehicle information in the notification.

In another embodiment, the notification can indicate location of the third vehicle. In a further embodiment, the computer executable components can further comprise a braking distance component configured to determine a braking distance required for the first vehicle to stop, further determine an available breaking distance, wherein the available braking distance is a distance from a current location of the first vehicle to the location of the third vehicle, and further determine whether the braking distance required for the first vehicle to stop is less than the available braking distance.

In another embodiment, the braking distance component can be further configured to, in the event of the braking distance required for the first vehicle to stop is less than the available braking distance, generate and transmit a second notification to the accident avoidance component indicating the first vehicle has sufficient distance to stop and avoid collision with the third vehicle. In a further embodiment, the accident avoidance component can be further configured to, in response to receiving the second notification, reduce an operational velocity of the first vehicle.

In a further embodiment, the braking distance component can be further configured to, in the event of the braking distance required for the first vehicle to stop is greater than the available braking distance, generate and transmit a third notification to the accident avoidance component indicating there is insufficient available braking distance for the first vehicle to avoid collision with the third vehicle, wherein the first vehicle and second vehicle are operating in a first lane of the road. In another embodiment, the accident avoidance component is further configured to, in response to receiving third notification, determine, whether there is an adjacent lane to the first lane of the road, in response to determining an adjacent lane is available, maneuver the first vehicle into the adjacent lane.

The computer executable components can further comprise a road condition component configured to adjust the braking distance required for the first vehicle to stop as a function of at least one of weather condition or road condition.

In other embodiments, elements described in connection with the disclosed systems can be embodied in different forms such as computer-implemented methods, computer program products, or other forms. For example, in an embodiment, a computer-implemented method can be performed by a device operatively coupled to a processor, wherein the device can be located on a first vehicle operating in at least a partially autonomous manner. In an embodiment, the method can comprise adjusting operation of the first vehicle based on a notification received from a second vehicle, wherein the notification indicates a collision present on a road being navigated by the first vehicle. In an embodiment, the collision involves the second vehicle and a third vehicle, and the notification further indicates current location of the third vehicle.

In an embodiment, the computer-implemented method can further comprise determining, by the device, a braking distance required for the first vehicle to stop, further determining, by the device, an available breaking distance, wherein the available braking distance is a distance from the current location of the first vehicle to the location of the third vehicle; and further determining, by the device, whether the braking distance required for the first vehicle to stop is less than the available braking distance. In another embodiment, in the event of the braking distance required for the first vehicle to stop is less than the available braking distance, the computer-implemented method can further comprise reducing, by the device, an operational velocity of the first vehicle. In a further embodiment, in the event of the braking distance required for the first vehicle to stop is greater than the available braking distance, the computer-implemented method can further comprise determining, by the device, whether there is an adjacent lane to the first lane of the road, and in response to determining an adjacent lane is available, navigating, by the device, the first vehicle into the adjacent lane.

Further embodiments can include a computer program product comprising a computer readable storage medium having program instructions embodied therewith, to mitigate occurrence of multi-vehicle collisions. The program instructions are executable by a processor located on a first vehicle, and can cause the processor to adjust operation of the first vehicle based on a notification received from a second vehicle, wherein the notification indicates a collision present on a road being navigated by the first vehicle, the collision can involve the second vehicle and a third vehicle, wherein the notification can further indicate a current location of the third vehicle.

In another embodiment, the program instructions are further executable by the processor to determine a braking distance required for the first vehicle to stop, further determine an available breaking distance, wherein the available braking distance is a distance from the current location of the first vehicle to the location of the third vehicle, and further determine whether the braking distance required for the first vehicle to stop is less than the available braking distance.

In another embodiment, in the event of the braking distance required for the first vehicle to stop is less than the available braking distance, the program instructions are further executable by the processor to cause the processor to reduce an operational velocity of the first vehicle.

In another embodiment, in the event of the braking distance required for the first vehicle to stop is greater than the available braking distance, the program instructions are further executable by the processor to cause the processor to determine whether there is an adjacent lane to the first lane of the road, and further, in response to determining an adjacent lane is available, navigate the first vehicle into the adjacent lane.

An advantage of the one or more systems, computer-implemented methods and/or computer program products can be utilizing various systems and technologies located on a first vehicle to inform a second vehicle of a collision, or potential collision, between the first vehicle and a third vehicle. The second vehicle can utilize the information received from the first vehicle to reduce a probability of the second vehicle from being involved in the collision between the first vehicle and the third vehicle. By vehicles sharing knowledge of one or more accidents, vehicles can adjust their behavior to prevent accidents involving two vehicles escalating into multi-vehicle pile-ups.

### DESCRIPTION OF THE DRAWINGS

One or more embodiments are described below in the Detailed Description section with reference to the following drawings.

FIGS. 1A-C present various configurations for a first vehicle to communicate with a second vehicle regarding an accident involving, or potentially involving, the first vehicle in an attempt to prevent the second vehicle from also being in the accident, in accordance with one or more embodiments.

FIG. 2 is a schematic presenting an example sequence of operations performed by respective vehicles and respective onboard systems operating to prevent/minimize probability of a vehicle collision, according to one or more embodiments.

FIG. 3 is a schematic illustrating an example scenario where an autonomous vehicle is to avoid being involved in a collision, in accordance with an embodiment.

FIG. 4 is a schematic illustrating an example scenario where an autonomous vehicle is distributing information regarding a collision/potential collision to other vehicles to enable the other vehicles to avoid being further involved in the collision, in accordance with an embodiment.

FIG. 5, is a schematic illustrating an example scenario where an autonomous vehicle is to avoid being involved in a collision, in accordance with an embodiment.

FIG. 6 is a schematic illustrating an example scenario where an autonomous vehicle is to avoid involvement in a collision, in accordance with an embodiment.

FIG. 7 is a schematic illustrating an example scenario where an autonomous vehicle is to avoid being involved in a collision, in accordance with an embodiment.

FIG. 8 is a schematic illustrating an example scenario where an autonomous vehicle is to avoid being involved in a collision, in accordance with an embodiment.

FIG. 9 is a schematic illustrating an example scenario where an autonomous vehicle is to avoid being involved in a collision, in accordance with an embodiment.

FIG. 10 is a schematic illustrating an example scenario where an autonomous vehicle is to avoid being involved in a collision, in accordance with an embodiment.

FIG. 11 is a schematic illustrating an example scenario where an autonomous vehicle is to avoid being involved in a collision, in accordance with an embodiment.

FIG. 12 illustrates a flow diagram for a computer-implemented methodology for a first vehicle determining operation of a second vehicle to avoid a multi-vehicle collision, in accordance with an embodiment, in accordance with at least one embodiment.

FIG. 13 illustrates a flow diagram for a computer-implemented methodology for a vehicle to avoid collision with another vehicle to avoid a multi-vehicle collision, in accordance with an embodiment, in accordance with at least one embodiment.

FIG. 14 illustrates a flow diagram for a computer-implemented methodology for a vehicle to activate various warnings to prevent another vehicle being involved in a multi-vehicle collision, in accordance with an embodiment, in accordance with at least one embodiment.

FIG. 15 is a block diagram illustrating an example computing environment in which the various embodiments described herein can be implemented.

FIG. 16 is a block diagram illustrating an example computing environment with which the disclosed subject matter can interact, in accordance with an embodiment.

FIG. 17 presents a summary of SAE J3016, detailing respective functions and features during Levels 0-5 of driving automation (per June 2018).

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

As used herein, “data” can comprise metadata. Further, ranges A-n are utilized herein to indicate a respective plurality of devices, components, signals etc., where n is any positive integer.

In the various embodiments presented herein, the disclosed subject matter can be directed to communications being established between respective vehicles operating on a road to enable a first vehicle, that is involved in an accident, to inform a second vehicle of the accident to enable the second vehicle to hopefully avoid the accident. By warning other vehicles of an accident, it may be possible to prevent a potentially low hazard accident, such as a rear end collision, from turning into a deadly accident involving multiple vehicles. Per the various embodiments presented herein, the chain of causation that leads to a minor rear-end collision escalating into a deadly pile-up may be severed by one or more vehicles being sufficiently forewarned of the accident to enable the one or more vehicles to perform a maneuver to avoid being caught up in the initial stages as a rear-end collision potentially escalates into a pile-up.

It is to be appreciated that for the sake of brevity, components, devices, systems, etc., that are described with regard to a first vehicle (e.g., vehicle 102) can have the same functionality as comparable components, devices, systems, etc., present onboard a second vehicle (e.g., vehicle 104). Hence, a first component onboard the first vehicle can have the same functionality as a comparable component present onboard a second vehicle, and vice versa. Accordingly, throughout this description, components, devices, etc., respectively located onboard the first vehicle (e.g., vehicle 102) and the second vehicle (e.g., vehicle 104) may be presented in pairs/counterparts, with the respective functionality available to both components. In an embodiment, the first vehicle and second vehicle can be operating autonomously, while a third vehicle (e.g., vehicle 106) can be operating non-autonomously, whereby, advantage can be taken of the various sensors and processes being conducted during operation of autonomous vehicles versus the potential for distracted, negligent, and/or reckless operation by a driver operating a vehicle (e.g., vehicle being driven non-autonomously or partially autonomously).

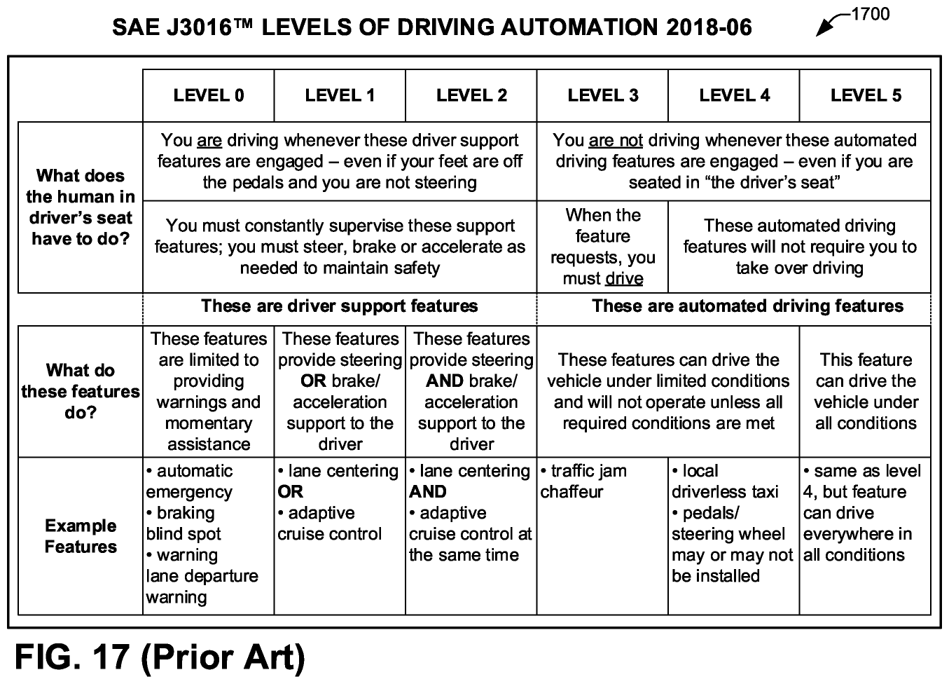

Regarding the phrase “autonomous” operation, to enable the level of sophistication of operation of a vehicle to be defined across the industry by both suppliers and policymakers, standards are available to define the level of autonomous operation. For example, the International Standard J3016 Taxonomy and Definitions for Terms Related to Driving Automation Systems for On-Road Motor Vehicles has been developed by the Society of Automotive Engineers (SAE) and defines six levels of operation of a driving automation system(s) that performs part or all of the dynamic driving task (DDT) on a sustained basis. The six levels of definitions provided in SAE J3016 range from no driving automation (Level 0) to full driving automation (Level 5), in the context of vehicles and their operation on roadways. Levels 0-5 of SAE J3016 are summarized below and further presented in FIG. 17, Table 1700.
Level 0 (No Driving Automation): At Level 0, the vehicle is manually controlled with the automated control system (ACS) having no system capability, the driver provides the DDT regarding steering, braking, acceleration, negotiating traffic, and suchlike. One or more systems may be in place to help the driver, such as an emergency braking system (EBS), but given the EBS technically doesn't drive the vehicle, it does not qualify as automation. The majority of vehicles in current operation are Level 0 automation.
Level 1 (Driver Assistance/Driver Assisted Operation): This is the lowest level of automation. The vehicle features a single automated system for driver assistance, such as steering or acceleration (cruise control) but not both simultaneously. An example of a Level 1 system is adaptive cruise control (ACC), where the vehicle can be maintained at a safe distance behind a lead vehicle (e.g., operating in front of the vehicle operating with Level 1 automation) with the driver performing all other aspects of driving and has full responsibility for monitoring the road and taking over if the assistance system fails to act appropriately.
Level 2 (Partial Driving Automation/Partially Autonomous Operation): The vehicle can (e.g., via an advanced driver assistance system (ADAS)) steer, accelerate, and brake in certain circumstances, however, automation falls short of self-driving as tactical maneuvers such as responding to traffic signals or changing lanes can mainly be controlled by the driver, as does scanning for hazards, with the driver having the ability to take control of the vehicle at any time.
Level 3 (Conditional Driving Automation/Conditionally Autonomous Operation): The vehicle can control numerous aspects of operation (e.g., steering, acceleration, and suchlike), e.g., via monitoring the operational environment, but operation of the vehicle has human override. For example, the autonomous system can prompt a driver to intervene when a scenario is encountered that the onboard system cannot navigate (e.g., with an acceptable level of operational safety), accordingly, the driver must be available to take over operation of the vehicle at any time.
Level 4 (High Driving Automation/High Driving Operation): advancing on from Level 3 operation, while under Level 3 operation the driver must be available, with Level 4, the vehicle can operate without human input or oversight but only under select conditions defined by factors such as road type, geographic area, environments limiting top speed (e.g., urban environments), wherein such limited operation is also known as “geofencing”. Under Level 4 operation, a human (e.g., driver) still has the option to manually override automated operation of the vehicle.
Level 5 (Full Driving Automation/Full Driving Operation): Level 5 vehicles do not require human attention for operation, with operation available on any road and/or any road condition that a human driver can navigate (or even beyond the navigation/driving capabilities of a human). Further, operation under Level 5 is not constrained by the geofencing limitations of operation under Level 4. In an embodiment, Level 5 vehicles may not even have steering wheels or acceleration/brake pedals. In an example of use, a destination is entered for the vehicle (e.g., by a passenger, by a supply manager where the vehicle is a delivery vehicle, and suchlike), wherein the vehicle self-controls navigation and operation of the vehicle to the destination.

To clarify, operations under levels 0-2 can require human interaction at all stages or some stages of a journey by a vehicle to a destination. Operations under levels 3-5 do not require human interaction to navigate the vehicle (except for under level 3 where the driver is required to take control in response to the vehicle not being able to safely navigate a road condition).

As referenced herein, DDT relates to various functions of operating a vehicle. DDT is concerned with the operational function(s) and tactical function(s) of vehicle operation, but may not be concerned with the strategic function. Operational function is concerned with controlling the vehicle motion, e.g., steering (lateral motion), and braking/acceleration (longitudinal motion). Tactical function (aka, object and event detection and response (OEDR)) relates to the navigational choices made during a journey to achieve the destination regarding detecting and responding to events and/or objects as needed, e.g., overtake vehicle ahead, take the next exit, follow the detour, and suchlike. Strategic function is concerned with the vehicle destination and the best way to get there, e.g., destination and way point planning. Regarding operational function, a Level 1 vehicle under SAE J3016 controls steering or braking/acceleration, while a Level 2 vehicle must control both steering and braking/acceleration. Autonomous operation of vehicles at Levels 3, 4, and 5 under SAE J3016 involves the vehicle having full control of the operational function and the tactical function. Level 2 operation may involve full control of the operational function and tactical function but the driver is available to take control of the tactical function.

Accordingly, the term “autonomous” as used herein regarding operation of a vehicle with or without a human available to assist the vehicle in self-operation during navigation to a destination, can relate to any of Levels 1-5. In an embodiment, for example, the terms “autonomous operation” or “autonomously” can relate to a vehicle operating at least with Level 2 operation, e.g., a minimum level of operation is Level 2: partially autonomous operation, per SAE J3016. Hence, while Level 2, partially autonomous operation, may be a minimum level of operation, higher levels of operation, e.g., Levels 3-5, are encompassed in operation of the vehicle at Level 2 operation. Similarly, a minimum Level 3 operation encompasses Levels 4-5 operation, and minimum Level 4 operation encompasses operation under Level 5 under SAE J3016.

It is to be appreciated that while the various embodiments presented herein are directed towards to one or more vehicles (e.g., vehicle 102) operating in an autonomous manner (e.g., as an AV), the various embodiments presented herein are not so limited and can be implemented with a group of vehicles operating in any of an autonomous manner (e.g., Level 5 of SAE J3016), a partially autonomous manner (e.g., Level 1 of SAE J3016 or higher), or in a non-autonomous manner (e.g., Level 0 of SAE J3016). For example, a first vehicle can be operating in an autonomous manner (e.g., any of Levels 3-5), a partially autonomous manner (e.g., any of levels 1-2), or in a non-autonomous manner (e.g., Level 0), while a second vehicle can also be operating in any of an autonomous manner, a partially autonomous manner, or in a non-autonomous manner.

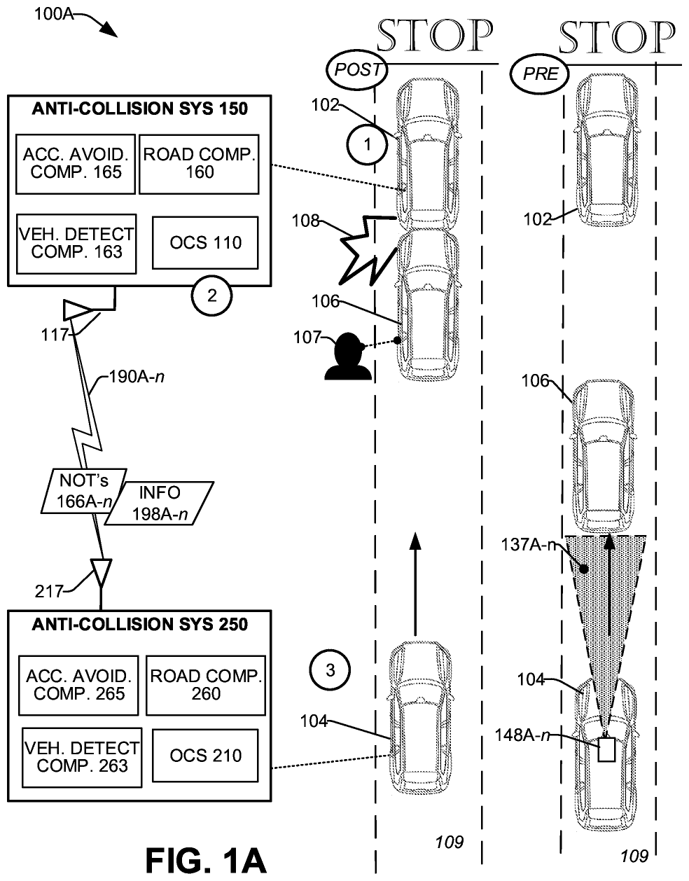

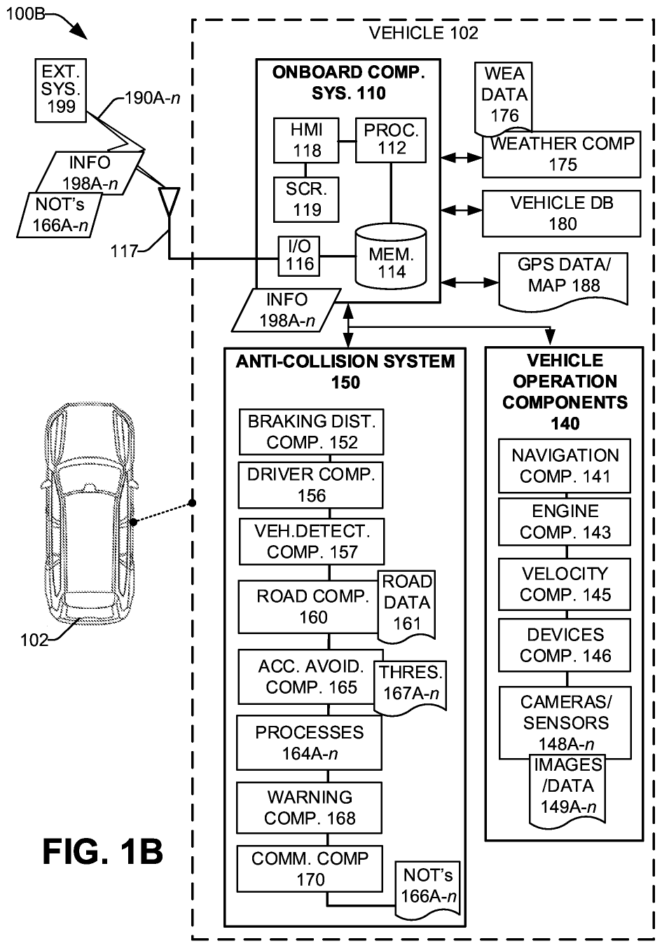

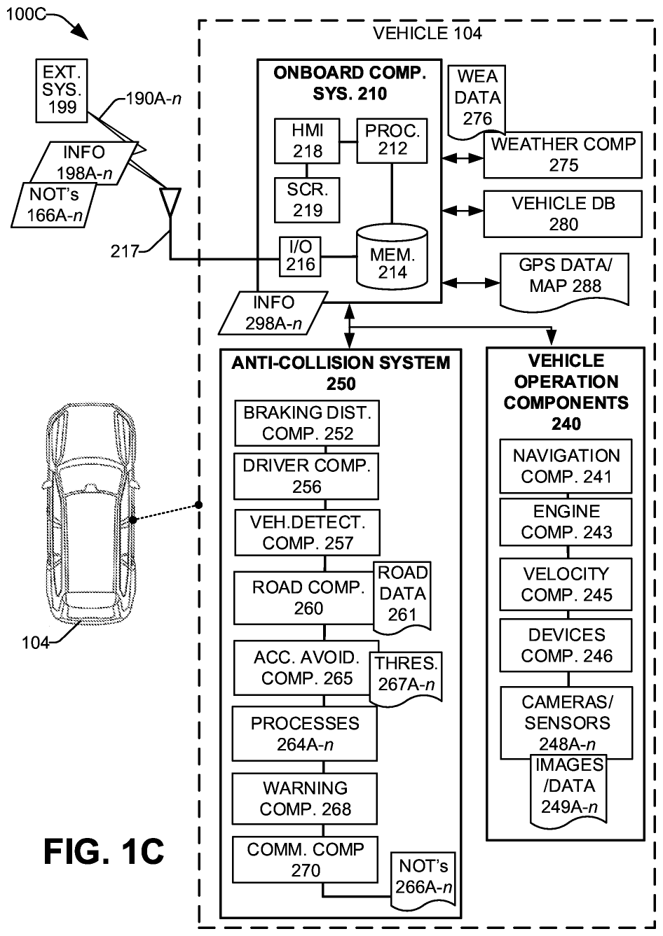

Turning to the figures, FIGS. 1A-C, systems 100A-C present various configurations for a first vehicle to communicate with a second vehicle regarding an accident involving, or potentially involving, the first vehicle in an attempt to prevent the second vehicle from also being in the accident, in accordance with an embodiment. As shown in FIG. 1A, in the “POST”-collision scenario, a vehicle 102 (e.g., the first vehicle) has been involved in a collision 108 with a vehicle 106 (e.g., a third vehicle) on a road 109 and is providing information (e.g., in notifications 166A-n) regarding the collision to vehicle 104 (e.g., a second vehicle). In the example scenario, vehicle 106 has rear-ended vehicle 102, e.g., as a result of vehicle 102 coming to a stop at a traffic light while vehicle 106 rear-ended vehicle 102, e.g., due to a driver 107 of vehicle 106 not paying attention (e.g., was texting), was speeding, did not leave sufficient braking distance, and suchlike. Multiple scenarios exist as to why vehicle 102 is stopped, slowing down/braking, including, in a non-limiting list: (a) stopping at a stop sign/traffic light, (b) stuck in a traffic jam and hence operating in a stop/start manner, (c) weather conditions, and suchlike.

As further shown in FIG. 1A, in the “PRE”-collision scenario, while vehicle 104 may have various onboard sensors (e.g., cameras/sensors 148A-n with respective field of view(s) or detection beam(s) 137A-n, as further described), the dimensions of vehicle 106 may be such that the various sensors 148A-n onboard vehicle 104 are occluded by vehicle 106 with regard to vehicle 104 detecting a presence of vehicle 102. Accordingly, vehicle 104 can be oblivious to the potential of vehicle 106 colliding with vehicle 102, as vehicle 104 is unaware of the presence of vehicle 102, and thus, the potential for vehicle 106 to collide with vehicle 102. Hence, there is potential for vehicle 104 to collide with vehicle 106 in the event of vehicle 106 coming to a sudden stop as a result of vehicle 106 colliding with vehicle 102 or vehicle 106 rapidly decelerating to avoid colliding with vehicle 102. Per the various embodiments presented herein, vehicle 102 can gather operational information/data regarding the operation of vehicle 106, probability of collision between vehicle 102 and 106, and suchlike, and share the operational information with vehicle 104 to enable vehicle 104 to operate in a pre-emptive manner to avoid a collision with vehicle 106, and hence potentially avoid a rear-end collision between vehicle 106 and 102 escalating into a multi-vehicle pile-up.

In an example scenario, vehicles 102 and 104 can be operating autonomously or partially autonomously, while vehicle 106 can be operating non-autonomously or partially autonomously.

As shown in FIG. 1A, an anti-collision system (ACS) 150 can be located onboard vehicle 102, and an ACS 250 can be located onboard vehicle 104, wherein the ACS 150 and ACS 250 can be configured to communicate with each other (e.g., via notifications 166A-n/information 198A-n transmitted via antenna 117 and 217 via signals 190A-n, and suchlike), as further described.

Accordingly, vehicle 102 (e.g., via the ACS 150) can be configured to obtain/generate information and make various determinations and inferences, and convey the respective information/determinations/inferences to vehicle 104, in an attempt to prevent vehicle 104 from being involved in the collision between vehicles 102 and 106, e.g., to prevent a two vehicle collision from becoming a pile-up. As further described, ACS 150 can include various components, devices, systems, etc., to mitigate/reduce probability of collisions occurring, wherein the ACS 150 can include a road component 160 (e.g., configured to obtain data/information regarding an environment/circumstances of an accident), a vehicle detection component 157 (e.g., to determine presence of, and respective distances between, vehicles involved or potentially involved in an accident), an accident avoidance component 165 (e.g., configured to determine probability of an accident occurring, etc.), wherein the ACS 150 can include an onboard computer system (OCS) 110 (e.g., comprising a processor, memory, etc.), wherein the OCS 110 can be a vehicle control unit (VCU). The OCS 110 can be utilized to provide overall operational control and/or operation of vehicle 102. Similarly, ACS 250 onboard vehicle 104 can include a road component 260 (e.g., configured to obtain data/information regarding an environment/circumstances of an accident), a vehicle detection component 257 (e.g., to determine presence of, and respective distances between, vehicles involved or potentially involved in an accident), an accident avoidance component 265 (e.g., configured to determine probability of an accident occurring, etc.), wherein the ACS 250 can include an onboard computer system 210 (e.g., comprising a processor, memory, etc.).

Further, the various embodiments presented herein can be applied to a myriad of scenarios. Such scenarios can include, in a non-limiting list: (a) vehicle 102 (e.g., operating autonomously) monitors operation of vehicle 106 (e.g., operating non-autonomously), vehicle 102 makes a determination that vehicle 106 is definitely going to collide (collision is imminent) with vehicle 102, and based thereon, vehicle 102 can generate a notification to vehicle 104 that vehicle 104 is driving towards an accident and if possible, maneuver to avoid being involved in the collision (e.g., brake, stop, maneuver into a different lane, and suchlike); (b) vehicle 102 monitors operation of vehicle 106 and determines that vehicle 106 has a probability (e.g., collision is possible (medium) to imminent (high)) of colliding with vehicle 102, and based thereon, vehicle 102 can generate a notification to vehicle 104 that vehicle 104 is driving towards a potential accident and if possible maneuver to avoid being involved in the collision, as required; (c) vehicle 102 can make a determination that vehicle 106 is being operated autonomously and thus issues regarding driver distraction are not present (e.g., zero probability of collision); (d) vehicle 102 monitors operation of vehicle 106 and determines that vehicle 106 is braking in a manner and has sufficient braking distance such that a collision between vehicle 102 and vehicle 106 will not occur or is low (e.g., zero probability of collision, collision is unlikely); (c) vehicle 102 can review operational data (e.g., weather conditions, road conditions, etc.) and make a determination based thereon regarding a probability that vehicle 106 can stop in time to avoid a collision with vehicle 102, and suchlike.

Turning now to FIGS. 1B and 1C, FIGS. 1B and 1C present respective system overviews 100B and 100C of the various devices, components, systems etc., that may be present on/utilized by respective vehicles to reduce rear-end collisions and pile-ups, in accordance with one or more embodiments. As mentioned, system 100B comprises a vehicle 102 with various devices and components located thereon, such as OCS 110. The OCS 110 can be utilized to provide overall operational control and/or operation of vehicle 102. In an embodiment, the OCS 110 can be configured to operate/control/monitor various vehicle operations, wherein the various operations can be controlled by one or more vehicle operation components 140 communicatively coupled to the OCS 110. The various vehicle operation components 140 can include a navigation component 141 configured to navigate vehicle 102 along a road as well as to control steering of the vehicle 102. The vehicle operation components 140 can further comprise an engine component 143 (aka a motor component) configured to control operation, e.g., start/stop, of an engine/motor configured to propel the vehicle 102.

The vehicle operation components 140 can further comprise a velocity component 145 configured to slow down or stop the vehicle 102 (e.g., when approaching a stop sign, an intersection, traffic lights, another vehicle, etc.). The velocity component 145 can also be configured to control acceleration of the vehicle 102 (e.g., to increase distance from a scene or potential scene of an accident), wherein braking and acceleration of the vehicle 102 can form part of the DDT operational function, as previously described. The velocity component 145 is further configured to receive data 149A-n pertaining to motion of vehicle 102 regarding at least one of velocity, deceleration, stationary, braking, acceleration, and suchlike, (e.g., generated by a motion/velocity sensor 148A-n). The velocity component 145 is further configured to determine a current motion (e.g., velocity) of vehicle 102.

Vehicle operation components 140 can further include a devices component 146, wherein the devices component 146 can be configured to control operation of various devices located on vehicle 102. The various devices can include devices to create a visual signal/alarm (e.g., headlights, hazard lights, and suchlike), and also devices to create an audible signal/alarm (e.g., car horn; an audible device such as a speaker configured to transmit and generate audible signals such as “warning, stopped vehicle ahead”, “warning, slow down, potential accident conditions”, and suchlike). The visual and audible signals/alarms can be generated and transmitted to be viewed/heard by drivers (e.g., drivers 107A-n) or visual/audio sensors (e.g., in sensors 148A-n) of other vehicles (e.g., generated by vehicle 102 to be received by any of vehicles 103A-n, 104A-n, and/or 106A-n, as further described).

The vehicle operation components 140 can further comprise various cameras and/or sensors 148A-n configured to monitor operation of vehicle 102 and further obtain imagery and other information regarding an environment/surroundings in which vehicle 102 is operating. The cameras/sensors 148A-n can include any suitable detection/measuring device, including cameras, optical sensors, laser sensors, Light Detection and Ranging (LiDAR) sensors, sonar sensors, audiovisual sensors, perception sensors, distance sensors, road lane sensors, motion detectors, velocity sensors, and the like, as employed in such applications as simultaneous localization and mapping (SLAM), and other computer-based technologies and methods utilized to determine an environment being navigated by vehicle 102, location of the vehicle 102 within the environment (e.g., location mapping), presence and operation of other vehicles (e.g., vehicles 104 and 106), distance between vehicles, braking distance, and suchlike.

In an embodiment, cameras/sensors 148A-n can be configured to capture and/or generate images/data 149A-n. e.g., visual images/information/data (e.g., based on light reflection/capture) from the environment/surroundings in a respective field of view 137A-n of cameras/sensors 148A-n, as well as also being respectively configured to generate data, etc., based upon transmission of transmission and reflection of a signal (e.g., an infra-red (IR) signal) in a detection beam(s) 137A-n, as further described. Images/data 149A-n, and the like generated by cameras/sensors 148A-n can be analyzed by processes 164A-n (aka, functions, operations, algorithms, etc.) to identify respective features of interest such as a license plate (e.g., license plate 211, as further described) of another vehicle, focus of attention of driver 107 (e.g., operating vehicle 106), presence of another vehicle (e.g., vehicles 103A-n, 104A-n, and/or 106A-n), a distance pertaining to an accident, e.g., length of vehicle 106, location of rear bumper of vehicle 106 at an accident (e.g., position BP, as further described), braking/stopping distance BD of a vehicle, etc. Further, the cameras/sensors 148A-n can be controlled by any of the respective components located onboard vehicle 102. For example, the vehicle detection component 157 (as further described herein) can control operation (e.g., on/off, direction/field of view, etc.) of the cameras/sensors 148A-n to enable detection of a vehicle (e.g., vehicles 103A-n, 104A-n, 106A-n) along with details of the vehicle (e.g., make, model, and/or colour) to enable determination of whether a vehicle is being operated/driven in a fully autonomous, partially autonomous, or non-autonomous manner, a dimension (e.g., length) of the vehicle, identification of a vehicle, and suchlike.

As mentioned, vehicle 102 can include ACS 150, wherein ACS 150 can further comprise various components that can be utilized to mitigate traffic accidents, e.g., rear-end collisions. As shown in FIG. 1B, ACS 150 can be communicatively coupled to the OCS 110, the vehicle operation components 140, and other components located onboard vehicle 102.

ACS 150 can further include a braking distance component 152 which can be configured to receive available braking distance data 149A-n indicating a distance available for a vehicle (e.g., vehicle 104A-n. 106A-n) to decelerate/brake/stop without colliding with vehicle 102. Available braking distance data 149A-n can be generated by a distance sensor 148D, wherein the distance sensor 148D can be configured to determine available breaking distance ABD between vehicle 102 and a vehicle 106 advancing towards vehicle 102, as further described.

In a further embodiment, ACS 150 can further include a driver component 156, wherein the driver component 156 can be configured to (i) determine a direction of gaze/focus of driver 107 of vehicle 106, (ii) determine whether driver 107 is engaged with their surroundings regarding operation of vehicle 106 relative, operation of vehicle 102, and such like. The driver component 156 can be configured to receive information/data 149A-n from the various on-board sensors and cameras 148A-n, as well as provided by processes 164A-n (e.g., a computer vision algorithm, digital imagery algorithm, and suchlike), and the like. In an embodiment, the direction of gaze of the driver 107 can be captured in images 149A-n and further determined by the driver component 156 in conjunction with processes 164A-n. Processes 164A-n can include face analysis, head position analysis, gaze analysis, eye/pupil detection, and suchlike, to detect driver 107's face. In the event that driver component 156 cannot fully determine driver 107's face, it may be inferred by the driver component 156 that driver 107 is looking at their phone, interacting with an onboard system (e.g., dashboard interface), or looking in any direction but along road 109 in the direction of vehicle 102.

ACS 150 can further include a vehicle detection component 157, wherein the vehicle detection component 157 can be configured to, in a non-limiting list, (i) detect one or more vehicles (e.g., any of vehicles 103A-n, 104A-n, 106A-n) also navigating the road 109 being navigated by the vehicle 102, (ii) identify and monitor operation (e.g., motion, direction) of the one or more vehicles (e.g., any of vehicles 103A-n. 104A-n. 106A-n), (iii) communicate with the other vehicle(s) (e.g., vehicles 104A-n), and suchlike, per the various embodiments presented herein. The vehicle detection component 157 can be configured to receive information regarding the vehicles 103A-n, 104A-n, 106A-n from data 149A-n generated by the cameras/sensors 148A-n, wherein the information can include make/model/colour of a respective vehicle, license plate number (e.g., license plate 211) of a respective vehicle, one or more dimensions of a respective vehicle, and suchlike. Further, the vehicle detection component 157 can access a vehicle database 180 (e.g., located onboard vehicle 102, and updated) which can provide make/model/colour, dimension information regarding vehicles 103A-n, 104A-n, 106A-n, as further discussed herein.

A road component 160 can be included in the ACS 150, wherein the road component 160 can analyze information (e.g., digital images/data 149A-n) from cameras/sensors 148A-n to identify respective lane markings and suchlike, from which the road component 160 can generate road data 161 regarding road 109 being navigated by any of vehicles 102, 103A-n, 104A-n. 106A-n, as well as from digital road maps 188 programmed into road component 160. Accordingly, the road data 161 can include information regarding a location (e.g., position C) at which the collision occurred and/or current/approximate location of vehicle 102, a lane L1-Ln in which an accident occurred, number of lanes L1-Ln available (e.g., for vehicle 104 to make an avoiding maneuver), width of the road 109, width of the lane(s) L1-Ln, presence of a shoulder lane on a highway, and the like. The road component 160 can further receive information from a GPS data/map system 188, wherein the GPS data/map system 188 can provide information to supplement the road data 161 (e.g., current location of vehicle 102 on road 109, number of lanes L1-Ln forming road 109, width of road 109, width of a lane(s), and the like). Further, the road component 160 can receive road information from an external system 199 (e.g., a remote GPS system) configured to further provide information regarding road 109 being navigated to further supplement road data 161.

The ACS 150 can further comprise various processes 164A-n respectively configured to determine information, make predictions, etc., regarding any of the road 109 being navigated, velocity/location/trajectory of any of vehicles 102, 103A-n, 104A-n, and/or 106A-n, a distance (e.g., a distance L based on length of vehicle 106 and current position of vehicle 102 relative to vehicle 106), potential intersection of a trajectory of vehicle 106 and either of vehicle 102 or 104, focus of attention of driver 107, and suchlike. Processes 164A-n can include a computer vision algorithm(s), a digital imagery algorithm(s), position prediction, velocity prediction, direction prediction, functions, operations, and suchlike, to enable the respective determinations, predictions, inferences, etc., per the various embodiments presented herein. Processes 164A-n can be utilized by any system/component/device located onboard vehicle 102.

An accident avoidance component (AAC) 165 can be further included in the ACS 150, wherein the AAC 165 can be configured to, in a non-limiting list: (i) determine/infer a probability/likelihood (e.g., imminent, possible, unlikely, zero likelihood) of an accident occurring between any of the respective vehicles 102, 103A-n, 104A-n, and/or 106A-n, (ii) in response to a determination/inference of a likelihood/probability of an accident occurring being above a threshold 167A-n (e.g., imminent, possible) alter operation of the vehicle 102, (iii) in response to a determination/inference of a probability of an accident occurring being above a threshold 167A-n, indicate to another vehicle (e.g., vehicle 104A-n) the probability of an accident occurring (e.g., between vehicle 102 and 106) such that the other vehicle can adjust operation/behavior to mitigate the probability of involvement in the accident, (iv) in response to a determination/inference of a probability of an accident occurring is below a threshold 167A-n (e.g., unlikely, zero likelihood) the vehicle 102 can maintain current operation, and suchlike. The AAC 165 can be configured to analyze the wealth of information generated (e.g., by any of the components located onboard vehicle 102) regarding any of the other vehicles 103A-n, 104A-n, 106A-n. (e.g., their respective speed, velocity, motion, trajectory of travel, and suchlike.) as well as the motion, speed, direction, etc., of vehicle 102 relative to the other vehicles 103A-n, 104A-n. 106A-n. The AAC 165 can be configured to generate one or more notifications 166A-n regarding a respective likelihood of an accident occurring between any of vehicles 102, 103A-n, 104A-n, and/or 106A-n, wherein the notifications 166A-n can be utilized by components onboard vehicle 102, as well as transmitting the notifications 166A-n to the other vehicles 103A-n. 104A-n, 106A-n.

The AAC 165 can be further configured to determine one or more actions for vehicle 102 to undertake to mitigate the likelihood of an accident occurring between vehicle 102 and vehicle 106. The various actions include, in a non-limiting list, any of: vehicle 102 slows down, stops, accelerates to increase a driving distance between vehicle 102 and vehicle 106 (e.g., to prevent a rear-end collision), change current lane of operation, attempt to communicate with vehicle 104, honk horn, emit an alarm/warning notice comprising a sound or a phrase such as “stop”, and suchlike.

The ACS 150 can further include a warning component 168. The warning component 168 can be configured to operate in conjunction with the AAC 165, wherein the warning component 168 can receive a notification 166A from the AAC 165 that a particular probability of collision (e.g., imminent, possible, unlikely, zero likelihood) currently exists between any of the respective vehicles 102, 103A-n, 104A-n, and/or 106A-n. In response to receiving the notification 166A, the warning component 168 can interact with the devices component 146 to initiate operation of the headlights, car horn, etc., to obtain the attention of driver 107, for example. In a further embodiment, as described herein, the warning component 168 can also generate a warning notification(s) 166A-n, via communications technology configured to interact between the vehicle 102 and any of vehicles 103A-n, 104A-n, 106A-n. The communications technology interaction can be undertaken via a communications component 170. The communications component 170 can be configured to communicate and interact with communication systems (e.g., communications system 270) respectively located onboard the vehicles 103A-n, 104A-n, 106A-n. The communications component 170 can be configured to establish and conduct communications with other vehicles 103A-n, 104A-n, 106A-n, external entities (e.g., drivers 107A-n) and systems, etc., e.g., via I/O 116. In an embodiment, the communications component 170 can be configured to generate and transmit an instruction 166A-n to other vehicles (e.g., any of vehicles 103A-n, 104A-n, 106A-n) requesting the respective vehicle identifies whether the respective vehicle is being operated in any of non-autonomously, partially autonomously, or fully autonomously. The communications component 170 can be further configured to receive an indication 166A-n from the respective vehicle (e.g., any of vehicles 103A-n, 104A-n, 106A-n) regarding operation of the respective vehicle. In an embodiment, the communications component 170 can generate the notification 166A-n requesting the respective vehicle identifies whether it is being operated non-autonomously, partially autonomously, or fully autonomously in response to a determination by the driver component 156 being unable to determine whether a respective vehicle has a driver 107 present.

As mentioned, vehicle 102 can also include a vehicle database 180, wherein the vehicle database 180 can comprise various vehicle identifiers such as makes/models/colours, a list of license plates and vehicles they are registered to, and suchlike, to enable determination of one or more features regarding a vehicle 103A-n. 104A-n, and/or 106A-n operating in the locality of vehicle 102 (e.g., detected by the vehicle detection component 157). Make/model/colour of vehicle 103A-n, 104A-n, and/or 106A-n can be determined from the license plate 211 and/or as determined by analysis of imagery 149A-n of vehicle 103A-n, 104A-n. 106A-n captured by the one or more cameras 148A-n and a computer vision algorithm(s) in processes 164A-n. In an embodiment, the vehicle database 180 can also include information regarding a respective length L of a vehicle 103A-n, 104A-n, and/or 106A-n. In an embodiment, the vehicle database 180 can also include information regarding whether vehicle 104 and/or 106 is configured to be driven autonomously, partially autonomously, or non-autonomously. By obtaining such information regarding autonomous, partial-, or non-autonomous operation, the vehicle detection component 157 can make a determination as to whether a particular vehicle 103A-n, 104A-n, and/or 106A-n is relying on a human driver 107 to operate the vehicle (e.g., vehicle 106), and if so, one or more components onboard vehicle 102 can focus attention on the driver 107 and/or operation of vehicle 106, while paying less attention to a vehicle (e.g., vehicle 104) that is being driven fully autonomously.

As shown in FIG. 1B, the OCS 110 can further include a processor 112 and a memory 114, wherein the processor 112 can execute the various computer-executable components, functions, operations, etc., presented herein. The memory 114 can be utilized to store the various computer-executable components, functions, code, etc., as well as road data 161, processes 164A-n, notifications 166A-n, thresholds 167A-n, information (e.g., motion, trajectory, location) regarding any of vehicles 102, 103A-n, 104A-n, and/or 106A-n, driver 107A-n, road 109, whether vehicle(s) 103A-n, 104A-n, and/or 106A-n is being operated autonomously, partially-autonomously, non-autonomously, and suchlike (as further described herein). In an embodiment, the vehicle operation components 140 can form a standalone component communicatively coupled to the OCS 110, and while not shown, the vehicle operation components 140 can operate in conjunction with a processor (e.g., functionally comparable to processor 112) and a memory (e.g., functionally comparable to memory 114) to enable navigation, steering, braking/acceleration, etc., of vehicle 102 to a destination. In another embodiment, the vehicle operation components 140 can operate in conjunction with the processor 112 and memory 114 of the OCS 110, wherein the various control functions (e.g., navigation, steering, braking/acceleration) can be controlled by the OCS 110. Similarly, the ACS 150 can form a standalone component communicatively coupled to the OCS 110, and while not shown, the ACS 150 can operate in conjunction with a processor (e.g., functionally comparable to processor 112) and a memory (e.g., functionally comparable to memory 114) to enable vehicle 104A-n/106A-n and/or driver 107A-n detection, e.g., during operation of vehicle 102. In another embodiment, the ACS 150 can operate in conjunction with the processor 112 and memory 114 of the OCS 110, wherein the various accident detection/mitigation functions can be controlled by the OCS 110. In a further embodiment, the OCS 110, vehicle operation components 140, and the ACS 150 (and respective sub-components) can operate using a common processor (e.g., processor 112) and memory (e.g., memory 114).

As further shown, the OCS 110 can include an input/output (I/O) component 116, wherein the I/O component 116 can be a transceiver configured to enable transmission/receipt of information 198 (e.g., a notification 166A-n, and suchlike) between the OCS 110 and any external system(s) (e.g., external system 199), e.g., an onboard system of vehicles 103A-n, 104A-n, and/or 106A-n, a cellphone, a GPS data system, and suchlike. I/O component 116 can be communicatively coupled, via an antenna 117, to the remotely located devices and systems (e.g., external system 199). Transmission of data and information 198A-n between the vehicle 102 (e.g., via antenna 117 and I/O component 116) and the remotely located devices and systems can be via the signals 190A-n. Any suitable technology can be utilized to enable the various embodiments presented herein, regarding transmission and receiving of signals 190A-n. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like. For example, 5G communication technologies exist such that it is possible for vehicle 102 to communicate with (e.g., generate and transmit notifications 166A-n) vehicles 104A-n in a timely manner (e.g., real-time, near real-time) enabling and of vehicles 104A-n to receive and process the notifications 166A-n enabling vehicle 104A-n to maneuver to avoid a rear-end collision, per the embodiments presented herein.

In an embodiment, the OCS 110 can further include a human-machine interface (HMI) 118 (e.g., a display, a graphical-user interface (GUI)) which can be configured to present various information including imagery of/information regarding any of vehicles 102, 103A-n, 104A-n, and/or 106A-n, road 109, the accident/collision 108, alarms, warnings (e.g., vehicle 102 is about to be hit by vehicle 106), information received from external systems and devices, and suchlike, per the various embodiments presented herein. The HMI 118 can include an interactive display 119 to present the various information via various screens presented thereon, and further configured to facilitate input of information/settings/etc., regarding operation of any of vehicles 102, 103A-n, 104A-n, and/or 106A-n. In an embodiment, in the event that vehicle 102 is being operated in an autonomous manner (e.g., Level 5 of SAE J3016), operation of the warning component 168 and notifications 166A-n can be utilized to present a warning on the HMI 118 and screen 119 to notify a passenger of vehicle 102 of the possible collision with vehicle 106 and/or 104, an accident avoiding maneuver being performed, and suchlike.

It is to be appreciated that while the term “notification” is presented herein with regard to notifications 166A-n, the content of notifications 166A-n is not limited to notifications, but can include data, information, instructions, requests, responses, and suchlike, and further the notifications 166A-n can be generated, transmitted, and/or received by any of the components located and operating onboard vehicle 102, and further to any of vehicles 103A-n, 104A-n, and/or 106A-n. The respective components are configured to analyze, generate, act upon, transmit, and receive information/data/notifications 166A-n between the components (e.g., vehicle operation components 140 and subcomponents, ACS 150 and subcomponents, communications component 170, vehicle database 180, GPS data 188, and the OCS 110), an external system 199, and further to other vehicles 103A-n, 104A-n, and/or 106A-n, and suchlike.

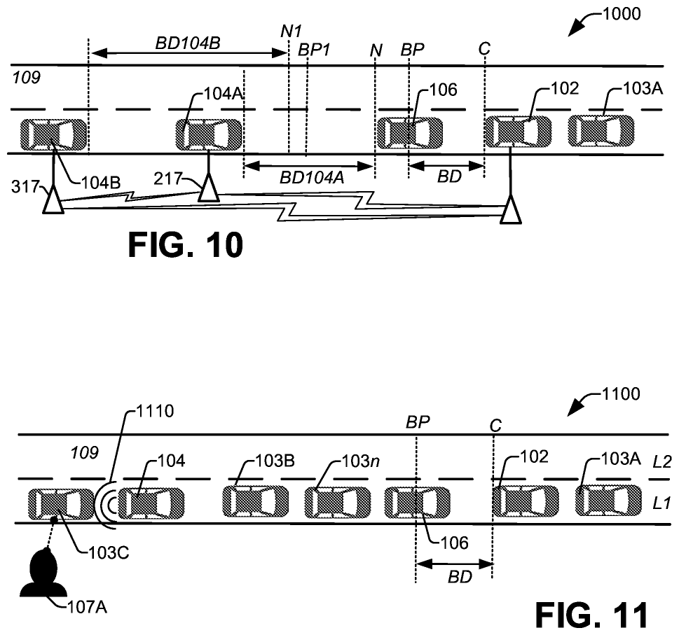

As mentioned, vehicles 102 and 104A-n can have comparable onboard components, systems, etc. To limit repetition, to determine functionality, operation, etc., of component, etc., depicted onboard vehicle 104, a system of numbering comparable components on vehicles 102 and 104A-n comprises a component 1XX on vehicle 102 is comparable to the counterpart component 2XX on vehicle 104/104A, and further comparable to the counterpart component 3XX on vehicle 104n (e.g., vehicle 104B presented in FIG. 10 herein). For example, AAC 265 (e.g., on vehicle 104 and/or 104A) and AAC 365 (e.g., on vehicle 104B) respectively have functionality comparable to AAC 165 (e.g., on vehicle 102). In another example, vehicle detection component 257 (e.g., on vehicle 104 and/or 104A) and vehicle detection component 357 (e.g., on vehicle 104B) respectively have functionality comparable to vehicle detection component 157 (e.g., on vehicle 102). Further, OCS' 110, 210, and 310, and their respective subcomponents, e.g., processors 112, 212, 312, memory 114, 214, 314, and suchlike (respectively located on vehicles 102, 104/104A, and 104B) have comparable functionality. Similarly, vehicle operation components 140, 240, 340 and respective subcomponents, have comparable functionality. Similarly, anti-collision systems 150, 250, and 350, and respective subcomponents, have comparable functionality. Further, where a system/component on vehicle 102 is indicated to be interacting with a system/component on vehicle 104A-n, the interaction can also function in reverse such that a system/component on vehicle 104A-n is able to interact with a system/component on vehicle 102.

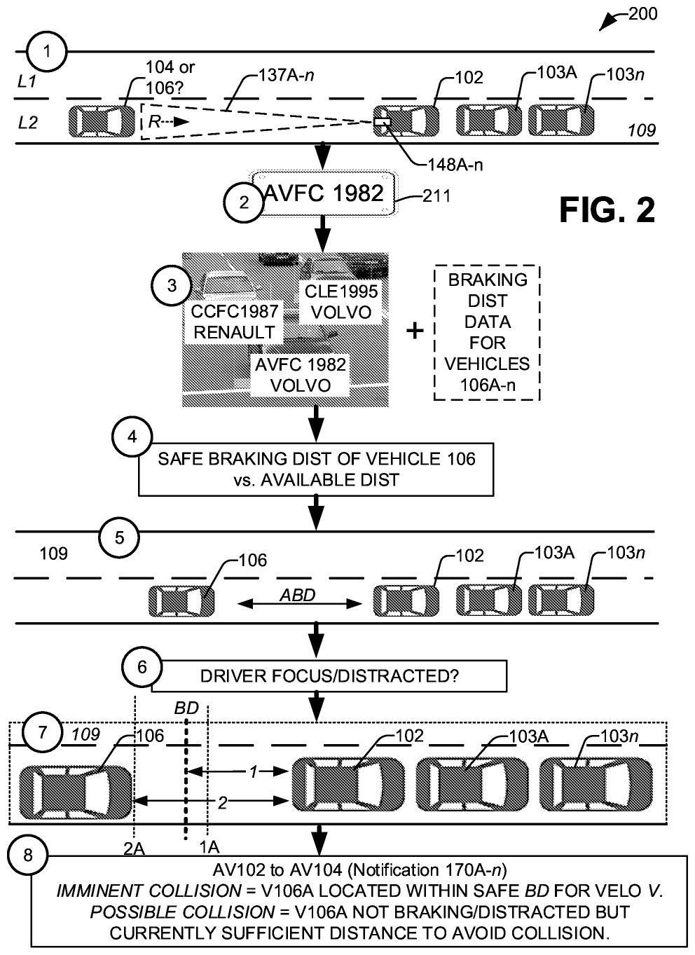

FIG. 2, schematic 200, presents an example sequence of operations performed by respective vehicles and respective onboard systems operating to prevent/minimize probability of a vehicle collision, according to one or more embodiments. FIG. 2 presents a sequence of events (1) to (8) regarding one or more determinations by various components and/or technologies onboard vehicle 102.

At (1), vehicle 102 is stationary/slow moving on road 109, wherein, in the example scenario, vehicle 102 is located behind two vehicles 103A and 103n, for example, vehicles 102, 103A, and 103n are stopped at a traffic light. Vehicles 103A-n can be of any type, e.g., autonomous, partially autonomous, or non-autonomously operated. While vehicle 102 is driving autonomously, the velocity component 145 can be operated (e.g., by OCS 110) to slow vehicle 102 to a stop behind vehicle 103A. A notification 166A-n can be generated (e.g., by velocity component 145, OCS 110, etc.) that vehicle 102 is braking/slowing/stopped, wherein the vehicle detection component 157 can be configured to, upon receipt of the braking notification 166A-n, initiate determination of whether a vehicle is approaching vehicle 102, e.g., in direction R, wherein potential collision of the vehicle could cause a rear-end collision with vehicle 102. At this moment in time, vehicle 102 does not know whether the approaching vehicle is an autonomous vehicle (e.g., a vehicle 104) or being operated non-autonomously (e.g., a vehicle 106), hence vehicle approaching from direction R is labeled as vehicle 104/106.

In an embodiment, vehicle 102 can also determine the current/approximate location at which it is stopped and/or driving slowly (e.g., in a slow moving traffic jam), wherein the location can be determined by the road component 160 in conjunction with GPS data/onboard map 188.

In a further embodiment, vehicle 102 can also determine a respective lane L1, L2, etc., of road 109 that vehicle 102 is currently located, e.g., in the event of vehicle 102 being rear-ended by vehicle 106. Road component 160 can be configured to determine the lane, e.g., based on images/data 149A-n of the road 109 (e.g., lane markings, etc.) in conjunction with analysis by processes 164A-n. In another embodiment, in the event of vehicle 106 colliding with vehicle 102, vehicle detection component 157 can be configured to provide a respective lane L1, L2, etc., that vehicle 106 is located in after the collision 108, in the event that as a function of the collision 108 vehicle 106 was caused to now be in lane L2 while it was originally navigating L1 prior to the collision.

In a further embodiment, while vehicle 102 is stationary (and also while slowing/braking), in the event that no vehicle is detected by the vehicle detection component 157, operation of the cameras/sensors 148A-n and vehicle detection component 157 can be maintained in an operation of vehicle detection (e.g., images/data 149A-n generated by the cameras/sensors 148A-n is reviewed by the vehicle detection component 157/processes 164A-n) until, (a) an approaching vehicle is detected and/or (b) the reason for vehicle 102 being stationary and/or moving slowly (e.g., traffic lights, in a traffic jam) no longer exists and vehicle 102 proceeds on road 109 (e.g., until reaching a destination, or another incident requiring braking/stopping is encountered).

Advancing to (2), in response to the vehicle detection component 157 detecting/determining that vehicle 104/106 is approaching in direction R, the vehicle detection component 157 can initiate one or more processes/operations to enable determination/identification of whether vehicle 104/106 is being operated autonomously or non-autonomously. The vehicle detection component 157 (e.g., in conjunction with processes 164A-n) can utilize the images/data 149A-n to detect a license plate 211 (or other distinguishing/unique identifier) on vehicle 104/106 and extract the license plate number for vehicle 104/106. The vehicle detection component 157 can be configured to review vehicle license data in vehicle database 180, wherein the license data can include whether the vehicle 104/106 is/can be operated fully autonomously, partially autonomously, non-autonomously. In response to a determination that vehicle is operating autonomously, e.g., as vehicle 104, the vehicle detection component 157 can be configured to not focus on vehicle 104 as vehicle 104 has various onboard sensors, etc., to minimize likelihood of collision with vehicle 102. In an alternative embodiment, the vehicle detection component 157 can transmit the license plate 211 number (e.g., as information 198A-n) to an external system 199, wherein external system 199 can include a database of license plate numbers, make/model/colour information, vehicle dimension information, braking distance information, and suchlike, wherein external system 199 can be configured to identify vehicle as a vehicle 104 or vehicle 106 and transmit the information (e.g., as information 198A-n) such that vehicle detection component 157 can identify vehicle 104/106 and proceed accordingly (e.g., terminate monitoring of vehicle 104 or continue monitoring vehicle 106).

At (3), in response to the vehicle detection component 157 determining that vehicle 106 is not operating autonomously, further review of vehicle 106 can be performed, e.g., make/model/colour of vehicle 106 identified with the corresponding length L of vehicle 106 and braking distance information BDI for vehicle 106 can be obtained. Further, vehicle detection component 157 can be configured to determine a velocity V of vehicle 106, e.g., based on a velocity sensor 148V configured to generate velocity data 149C.

At (4), the ACS 150 can utilize the braking distance component 152 to determine the available braking distance ABD (as previously mentioned) between vehicle 102 and vehicle 106, and further, can compare the ABD with the specified braking distance for vehicle 106. The braking distance component 152 can utilize road data 161 (e.g., generated by road component 160) regarding the road conditions (e.g., road 109 is icy, wet, dry, and suchlike, e.g., as determined from data 149A-n generated by cameras/sensors 148A-n) and further supplement the road data 161 with weather data 176 generated by weather component 175. Wherein the road data 161 and weather data 176 can be utilized by the braking distance component 152 to determine the braking distance BD of vehicle 106 under the current conditions of road 109. The values ABD and BD can be generated and transmitted (e.g., in notifications 166A-n) by the braking distance component 152. In another embodiment, the braking distance component 152 can be configured to determine a current location of vehicle 102 (e.g., based on road data 161, GPS data/map data 188) and further obtain a length L of vehicle 106 such that the braking distance component 152 can make a determination as to, in the event of vehicle 106 collides into vehicle 102, a position BP of vehicle 106 that vehicle 104 needs to stop prior to/maneuver around to prevent vehicle 104 colliding with vehicle 106 (e.g., bumper position BP=current position of vehicle 102 adjusted by length L).

At (5) and (6), the ACS 150 can utilize various information to determine a probability (e.g., via thresholds 167A-n) of collision between vehicle 106 and 102 is imminent (e.g., 90% chance of collision), possible (e.g., 35-90% chance of collision), or unlikely (e.g., less than 35% chance of collision), etc. The driver component 156 can be configured to determine whether driver 107 operating vehicle 106 is distracted or engaged with the road 109, location of vehicle 102, and suchlike. As previously mentioned, images/data 149A-n generated by cameras/sensors 148A-n can be analyzed by the driver component 156 (e.g., in conjunction with processes 164A-n) to determine a current degree of distraction of driver 107. The driver component 156 can be configured to generate and transmit (e.g., in notifications 166A-n) a distraction measure DM for driver 107, e.g., DM=focused/paying attention to road conditions, DM=is distracted, and suchlike. The DM in notification 166A-n can be received by the AAC 165, wherein the AAC 165 can be further configured to adjust the BD for vehicle 106 in accordance with the DM value. For example, vehicle 106 may be detected (e.g., by vehicle detection component 157) at a distance in excess of the BDI (e.g., ABD>BD) but owing to the DM value, the AAC 165 can be configured to increase the BD (e.g., to a distractedBD) to account for driver 107 being distracted and hence may need a longer braking distance than BD.

Accordingly, in the event of the distractedBD>ABD, AAC 165 can make an inference that vehicle 106 will collide with (e.g., rear-end) vehicle 102. In an example scenario, driver 107 is detected to not be applying the brakes to/braking vehicle 106 (e.g., by vehicle detection component 157) and driver 107 is distracted (e.g., face not detected to be facing forward by driver component 156), hence AAC 165 makes an inference that driver 107 will not act to cause vehicle 106 to decelerate to avoid collision with vehicle 102, with a further determination (e.g., by AAC 165) of a collision is imminent given vehicle 106's current velocity, available braking distance ABD, and suchlike. In another example, driver 107 is detected to not be applying the brakes to/braking vehicle 106 (e.g., by vehicle detection component 157) and while driver 107's face is determined to be facing forward (e.g., by driver component 156), driver 107's pupils are not detected (e.g., by driver component 156) to be incident upon vehicle 102, hence AAC 165 makes an inference that driver 107 will not cause vehicle 106 to decelerate to avoid collision with vehicle 102, with a further determination (e.g., by AAC 165) of a collision is imminent given vehicle 106's current velocity, available braking distance ABD, and suchlike. Hence, based on such variables as condition of road 109, velocity of vehicle 106, available braking distance ABD, braking distance BD of vehicle 106, distracted braking distance distractedBD of vehicle 106, and suchlike, the AAC 165 can make an inference of whether vehicle 106 will collide with vehicle 102. The respective inference/determination of collision (e.g., imminent, possible, or unlikely) can be continually reassessed by the AAC 165 based upon the respective changes to operation of vehicle 106 by driver 107, distractedness of driver 107, and suchlike.

At (7), a couple of example scenarios are depicted. In a 1st scenario where vehicle 106 is detected (e.g., by vehicle detection component 157) at location 1A, which is less than the BD of vehicle 106 for a given velocity V, collision of vehicle 106 with vehicle 102 can be determined (e.g., by AAC 165) to be imminent. In a 2nd scenario where vehicle 106A is detected (e.g., by vehicle detection component 157) at location 2A, the distance between vehicle 106A and vehicle 102 is greater than the required braking distance BD, and a collision is determined (e.g., by AAC 165) to be unlikely (e.g., as driver 107 is paying attention to the road 109) or possible (e.g., as driver 107 is distracted but sufficient braking distance exists in the event of the driver 107 pays attention to the road 109 and brakes vehicle 106 or not).

At (8), the AAC 165 can be configured to transmit (e.g., in notifications 166A-n and/or information 198A-n via signals 190A-n) the respective inference (e.g., imminent or possible, unlikely inferred/determined by AAC 165) from vehicle 102 to vehicle 104. In an embodiment, in response to an inference/determination of collision is unlikely, AAC 165 can be configured to not transmit the collision probability information to vehicle 104 (e.g., to minimize use of communication bandwidth of signals 190A-n). Other information also transmitted from vehicle 102 to vehicle 104 can include, in a non-limiting list: (a) the license plate 211 of vehicle 106 to enable the vehicle detection component 257 onboard vehicle 104 to identify vehicle 106, (b) vehicle 102's current location on road 109, (c), length of vehicle 106 and corresponding bumper position BP, (d) current lane L1, L2, etc., in which vehicle 102 is located, (e) a current lane L1, L2, etc., in which vehicle 106 is located, (f) any other information/data generated or obtained by the one or more systems, components, etc., onboard vehicle 102 that can be utilized by vehicle 104 to avoid colliding with vehicle 106.

In another embodiment, in response to an inference/determination of collision is unlikely, AAC 165 can be configured to transmit the collision probability information to vehicle 104 to facilitate identification of vehicle 106 by 104.

It is to be appreciated that the example scenario(s) presented in FIG. 2, are one of many that can occur in accordance with the various embodiments presented herein given the number and variety of parameters, measurements, determinations, inferences, etc., that can exist.

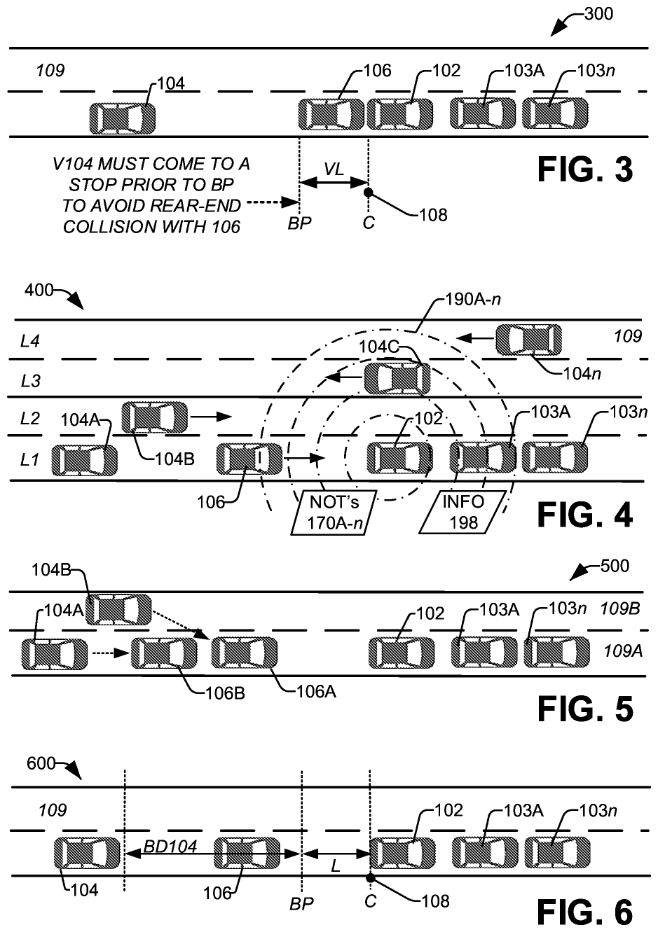

Turning to FIGS. 3-11, schematics 300-1100, various scenarios of operation of vehicle 104 are presented in avoiding collision with vehicle 106. Owing to the variety of circumstances that can lead to vehicle 104 operating to avoid colliding with vehicle 106, rather than one specific sequence of events being depicted, various event instances are provided which can be combined to create a sequence of events. Further, while various events are presented regarding operation of vehicle 104 and interaction with vehicle 102 and/or 106, a variety of similar events can occur that while not specifically depicted in FIGS. 3-11, the various embodiments presented herein pertain to.

FIG. 3, schematic 300 illustrates an example scenario where an autonomous vehicle is to avoid being involved in a collision, in accordance with an embodiment. As shown, to avoid collision (e.g., rear-ending) vehicle 106, vehicle 104 must come to a stop (or maneuver around) prior to bumper position BP, wherein BP is the position of the portion of the vehicle bodywork of vehicle 106 that is nearest to vehicle 104 as it advances towards vehicle 106. As previously mentioned, BP can be determined by vehicle 102 (e.g., by vehicle detection component 157, AAC 165) as a function of the rear position of vehicle 106 at collision 108 (e.g., BP=current position C of vehicle 102 plus length L of vehicle 106). In the example scenario shown in FIG. 3, vehicles 102, 103A-n, and/or 106 can be moving slowly in a traffic jam, vehicles 103A-n and vehicle 102 are stopped with vehicle 106 rear-ending vehicle 102.

FIG. 4, schematic 400 illustrates an example scenario where an autonomous vehicle is distributing information regarding a collision/potential collision to other vehicles to enable the other vehicles to avoid being further involved in the collision, in accordance with an embodiment. As shown, vehicle 102 is monitoring operation of vehicle 106, e.g., per FIG. 2, act (1). In an embodiment, rather than transmitting notifications 166A-n and/or information 198 to a specific vehicle, vehicle 102 can transmit the notifications 166A-n and/or information 198 in a global/unrestricted manner such that any vehicle 104A-n in transmission range of signals 190A-n can receive the notifications 166A-n and/or information 198 conveyed in signals 190A-n. In an embodiment, vehicles 104A-n that do not require information 198, etc., can be configured to review and ignore the particular transmitted notifications 166A-n. For example, vehicle 102 can transmit (e.g., via I/O component 116, communications component 170, antenna 117, signals 190A-n, and suchlike) notifications 166A-n that detail particular lanes of road 109 in which a collision may occur or has occurred. Accordingly, those vehicles 104A-n which may have use of the information in notifications 166A-n can be configured to receive, process, and further act upon the information in notifications 166A-n, while those vehicles 104A-n which may not have use of the information in notifications 166A-n can be configured to receive, process, but further ignore the information in notifications 166A-n. For example, vehicle 102 transmits signals 190A-n which include notifications 166A-n detailing that vehicle 106 travelling in lane L/may collide with vehicle 102. Accordingly, the notifications 166A-n may be of interest to vehicles 104A and 104B travelling in lanes L/and L2, in the same direction as vehicles 102 and 104, are proximate to vehicle 104 regarding having the potential to be involved in a collision with vehicle 104. Further, operation of vehicles 104A and 104B are likely constrained to lanes L1 and L2 owing to oncoming traffic in lanes L3 and L4 and/or lanes L1/L2 are separated from lanes L3/L4 by a median or other traffic divider. Owing to vehicles 104C and 104n navigating lanes L3 and L4 and travelling in the opposite direction of vehicles 102 and 104 (vehicles 104C and 104n will likely not be involved in the collision 108), vehicles 104C and 104n can ignore the notifications 166A-n as the information 198 conveyed in notifications 166A-n does not pertain to vehicles 104C and 104n. Vehicles 103A-n can be of any type, e.g., autonomous, partially autonomous, or non-autonomously operated, and moving slowly or stopped.

FIG. 5, schematic 500 illustrates an example scenario where an autonomous vehicle is to avoid being involved in a collision, in accordance with an embodiment. As shown, vehicle 102 may be stopped/driving slowly behind vehicles 103A-n. As previously mentioned with regard to FIG. 4, vehicle 102 can provide information (e.g., notifications 166A-n, information 198A-n) to vehicles 104A-n regarding a collision or potential collision involving vehicle 106 and vehicle 102. As also mentioned, vehicles 104A-n can utilize the information to pre-emptively avoid a collision with vehicle 106. In an embodiment, the information transmitted from vehicle 102 to vehicles 104A-n can, as previously mentioned, include one or more items of information to enable vehicles 104A-n to identify vehicle 106. The one or more items of information can include license plate number 211, make/model/colour of vehicle 106, and suchlike. Respective systems and components onboard respective vehicles 104A-n can utilize the received information 198A-n and notifications 166A-n to determine/identify location of vehicle 106A-n of interest. For example, vehicle 104A can make a determination that vehicle 106B is not the vehicle of interest identified in the information 198A-n, while, similarly, vehicle 104B can make a determination that vehicle 106A is the vehicle of interest to which information 198A-n transmitted by vehicle 102 pertains.

As previously mentioned (e.g., per FIG. 1, pre-collision), detection of a first vehicle by a second vehicle may be prevented owing to the first vehicle being occluded by a third vehicle. Hence, in the scenario presented in FIG. 5, vehicle 104A may not be aware of vehicle 106A as a function of vehicle 106B occluding cameras/sensors 248A-n onboard vehicle 104A. Hence, vehicle 104A could continue to operate in a manner that, given vehicle 104A is unaware of vehicle 106A (and the potential for vehicle 106A to collide with vehicle 102), vehicle 104A operates in a manner having no regard for the potential collision between vehicle 106A and vehicle 102. However, based on the information 198A-n, a vehicle detection onboard vehicle 104B can detect the presence of vehicle 106A. Accordingly, vehicle 104B can operate in a manner to mitigate involvement in a collision between vehicles 106A and 102, e.g., vehicle 104B can slow down, stop, or accelerate to distance vehicle 104B from the location of collision 108 between vehicle 106A and 102. Further, in another embodiment, vehicle 104B can transmit information to vehicle 104A indicating the presence of vehicle 106A is in front of vehicle 106B, and, in response to receiving the information, vehicle 104A can operate to pre-emptively avoid the collision between vehicles 102 and 106A and hence reduce the likelihood of a multi-vehicle pile-up resulting from a rear-end collision between vehicles 102 and 106A.

Hence, per embodiments presented in FIGS. 4 and 5, information initially generated and shared by vehicle 102, can be further shared between other vehicles 104A-n with vehicles of interest (e.g., vehicle 106A) being identified amongst the vehicles 104A-n.

FIG. 6, schematic 600 illustrates an example scenario where an autonomous vehicle is to avoid involvement in a collision, in accordance with an embodiment. As shown, vehicle 102 may be stopped or driving slowly behind stopped/slowly driving vehicles 103A-n. As previously mentioned, vehicle 102 can transmit to vehicle 104 information regarding the current location of vehicle 102 and information regarding vehicle 106, including the length L of vehicle 106. By knowing position C (here position 108 is used to denote a potential location of a collision between vehicle 102 and 106) and length L, BP of vehicle 106 can be determined by vehicle 104, and further vehicle 104 knows it requires a braking distance of BD104. Based on location knowledge available to vehicle 104 (e.g., generated by ACS 250 onboard vehicle 204, such as road component 260 in conjunction with processes 264A-n and GPS data/map data 288, for example), vehicle 104 can make a determination as to distance BD104 is sufficient for vehicle 104 to decelerate/stop without colliding with vehicle 106, e.g., distance BD104 is prior to position BP. By being forewarned (e.g., by vehicle 102) of the potential of rear-ending vehicle 106, vehicle 104 can brake/maneuver to avoid collision with vehicle 106.

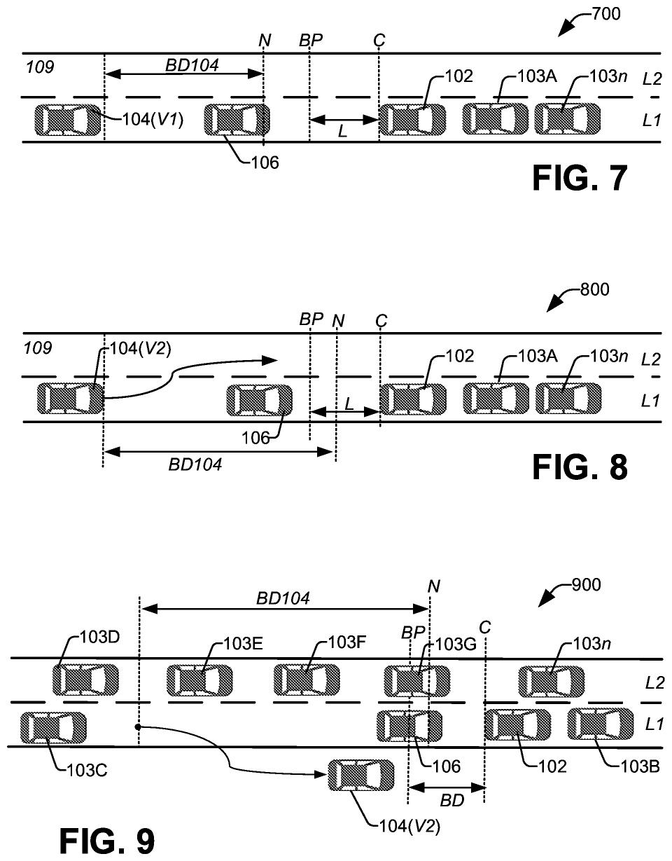

FIG. 7, schematic 700 illustrates an example scenario where an autonomous vehicle is to avoid being involved in a collision, in accordance with an embodiment. As shown, vehicle 102 may be stopped or driving slowly behind stopped/slowly driving vehicles 103A-n. In the event of vehicle 106 rear-ends vehicle 102 at position C, as previously described, the rear of vehicle 106 will be at position BP. As previously described, vehicle 104 can make a determination of the required braking distance BD104. In the scenario presented in FIG. 7, braking distance BD104 ends at position N, and with N being before position BP, vehicle 104 can make a determination that vehicle 104 at velocity V1 (e.g., 40 kph/25 mph) has sufficient braking distance available. Accordingly, vehicle 104 can brake while remaining in lane L1.

FIG. 8, schematic 800 illustrates an example scenario where an autonomous vehicle is to avoid being involved in a collision, in accordance with an embodiment. As shown, vehicle 102 may be stopped or driving slowly behind stopped/slowly driving vehicles 103A-n. In the event of vehicle 106 rear-ends vehicle 102 at position C, as previously described, the rear of vehicle 106 will be at position BP. As previously described, vehicle 104 can make a determination of the required braking distance BD104. In the scenario presented in FIG. 8, braking distance BD104 ends at position N, and with N being after position BP, vehicle 104 can make a determination that vehicle 104 at velocity V2 (e.g., 95 kph/60 mph) has insufficient braking distance available. Accordingly, vehicle 104 can make a further determination as to whether it is safe/possible to change lanes from L1 to L2. A determination of safe to change from L1 to L2 can be performed by AAC 265 in conjunction with images/data 249A-n, road data 261, and vehicle detection component 263. In response to a determination that YES, changing lanes from L1 to L2 is a viable option, vehicle 104 can maneuver to avoid colliding with vehicle 106, e.g., by changing current lane of navigation L1 to lane L2 (and decelerating as doing so, if required).

FIG. 9, schematic 900 illustrates an example scenario where an autonomous vehicle is to avoid being involved in a collision, in accordance with an embodiment. As shown, vehicle 102 may be stopped or driving slowly behind stopped/slowly driving vehicles 103A-n. In the event of vehicle 106 rear-ends vehicle 102 at position C, as previously described, the rear of vehicle 106 will be at position BP. As previously described, vehicle 104 can self-determine the required braking distance BD104. In the scenario presented in FIG. 9, braking distance BD104 ends at position N, and with N being after position BP, vehicle 104 can make a determination that vehicle 104 at velocity V2 (e.g., 95 kph/60 mph) has insufficient braking distance available. Accordingly, vehicle 104 can make a further determination as to whether it is safe/possible to change lanes from L1 to L2. In response to a determination that NO, changing lanes from L1 to L2 is not a viable option, vehicle 104 can maneuver to avoid colliding with vehicle 106, e.g., by changing current lane of navigation L1 to the shoulder of the road 109, and coming to a stop, if required.

FIG. 10, schematic 1000 illustrates an example scenario where an autonomous vehicle is to avoid being involved in a collision, in accordance with an embodiment. As shown, vehicle 102 may be stopped or driving slowly behind stopped/slowly driving vehicles 103A-n. In the event of vehicle 106 rear-ends vehicle 102 at position C, as previously described, the rear of vehicle 106 will be at position BP. As previously described, vehicle 102 can inform multiple vehicles 104A-n (e.g., via notifications 166A-n and signals 190A-n between respective onboard communication systems respectively associated with antenna 117, 217, and 317) regarding operation of vehicle 106 and likelihood of an accident occurring. Further, vehicles 104A and 104B can also exchange notifications 166A-n to avoid a collision. In the example scenario presented in FIG. 10, in the event of vehicle 106 crashing into vehicle 102, the rear of vehicle 106 will be at position BP. Accordingly, vehicles 104A and 104B are able to self-determine (e.g., via respective AACs 265 and 365) whether the vehicles 104A and 104B respectively have sufficient braking distance for vehicle 104A to not rear-end vehicle 106, and further, for vehicle 104B to not rear-end vehicle 104A. As shown, with the rear of vehicle 106 being at position BP, vehicle 104A self determines (e.g., automatically via AACs 265) that vehicle 104A has sufficient distance to stop prior to position BP of vehicle 106. Further, with the rear of vehicle 104A being at position BPI, vehicle 104B self determines (e.g., automatically via accident avoidance components 365) that vehicle 104B has sufficient distance to stop prior to position BPI of vehicle 104A.

FIG. 11, schematic 1100 illustrates an example scenario where an autonomous vehicle is to avoid being involved in a collision, in accordance with an embodiment. As shown, vehicle 102 may be stopped or driving slowly behind stopped/slowly driving vehicles 103A-n. In the event of vehicle 106 rear-ends vehicle 102 at position C, as previously described, the rear of vehicle 106 will be at position BP. As previously described, vehicle 102 can inform vehicle 104 regarding operation of vehicle 106 and likelihood of an accident occurring.

In the example scenario presented in FIG. 11, multiple vehicles 103B-n can be located between vehicle 102 and 104, wherein vehicle 103C is completely unaware of the potential for accident between vehicle 106 and vehicle 102. However, given vehicle 102 can inform vehicle 104 of the collision/potential collision between vehicle 102 and 106, vehicle 104 can operate to influence operation of vehicle 103C. In response to receiving information regarding the collision/potential collision, vehicle 104 can self-determine (e.g., by AAC 265) that, given current braking distances, velocities, etc., no collision will occur between vehicle 104 and vehicle 103B, vehicle 104 can operate to raise awareness of a driver 107A operating vehicle 103C that an incident has occurred/can potentially occur. In an embodiment, vehicle 104 can raise awareness of driver 107A by slowing down, operating a warning 1110 such as a visible warning (e.g., hazard lights), generating an audible alarm (such as “warning, potential accident ahead”), and suchlike. In an example operation, in response to a determination that no collision will occur, AAC 265 onboard vehicle 104 can generate a notification 266A-n instructing warning component 268 to generate a warning notification 266A-n instructing devices component 246 to operate various devices/components to generate an audible and/or visual warning(s) directed at vehicle 103C.

As mentioned, AAC 165 can conduct one or more determinations of whether a collision may occur between vehicle 102 and 106, e.g., as a combination of a function of vehicle 106's velocity, conditions of road 109, distractedness of driver 107, and suchlike, wherein the determinations can be based on a threshold 167A-n. The value of threshold 167A-n can be arbitrary/user defined at AAC 165. Per the prior examples, threshold of 90% chance of collision=imminent, 35-90% chance of collision=possible (e.g.), less than 35% chance of collision=unlikely, 0%=zero chance of collision. Similarly, AAC 265 can conduct one or more determinations of whether a collision may occur between vehicle 104 and 106 based on a threshold 267A-n. The value of threshold 267A-n can be arbitrary/user defined at AAC 265.

As used herein, the terms “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Per the various embodiments presented herein, various components included in the ACS 150, e.g., braking distance component 152, driver component 156, vehicle detection component 157, road component 160, AAC 165, and suchlike (and comparable components on vehicles 104A-n), and associated processes 164A-n (and comparable processes 264A-n on vehicles 104A-n) can include machine learning and reasoning techniques and technologies that employ probabilistic and/or statistical-based analysis to prognose or infer an action that a user desires to be automatically performed. The various embodiments presented herein can utilize various machine learning-based schemes for carrying out various aspects thereof. For example, a process for determining (a) braking distance of vehicle 106, (b) distractedness of driver component 156, (c) detection of vehicles 104A-n, 106A-n, 103A-n, (d) conditions of road 109, (c) accident avoidance, and suchlike, as previously mentioned herein, can be facilitated via an automatic classifier system and process.

A classifier is a function that maps an input attribute vector, x=(x1, x2, x3, x4, xn), to a class label class (x). The classifier can also output a confidence that the input belongs to a class, that is, ƒ(x)=confidence (class (x)). Such classification can employ a probabilistic and/or statistical-based analysis (e.g., factoring into the analysis utilities and costs) to prognose or infer an action that a user desires to be automatically performed (e.g., avoidance of an accident, and operations related thereto).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to predetermined criteria, probability of an accident in conjunction with avoidance of an accident, for example.

As described supra, inferences can be made, and operations performed, based on numerous pieces of information. For example, information/data regarding location/operation of vehicles 102, 103A-n, 104A-n, and/or 106A-n, weather conditions 176, road conditions 161, images/data 149A-n, presence and distractedness of driver 107, etc., as operation of vehicle 102 continues is compiled with information/data generated by the respective components included in, or in communication with, the AAC 165 and the information/data accumulated (e.g., in memory 114) regarding other vehicles 103A-n, 104A-n, and/or 106A-n, road conditions 161, and suchlike, enabling analysis determine converging patterns such that inferences can be made regarding sound events and the likely occupant reaction.

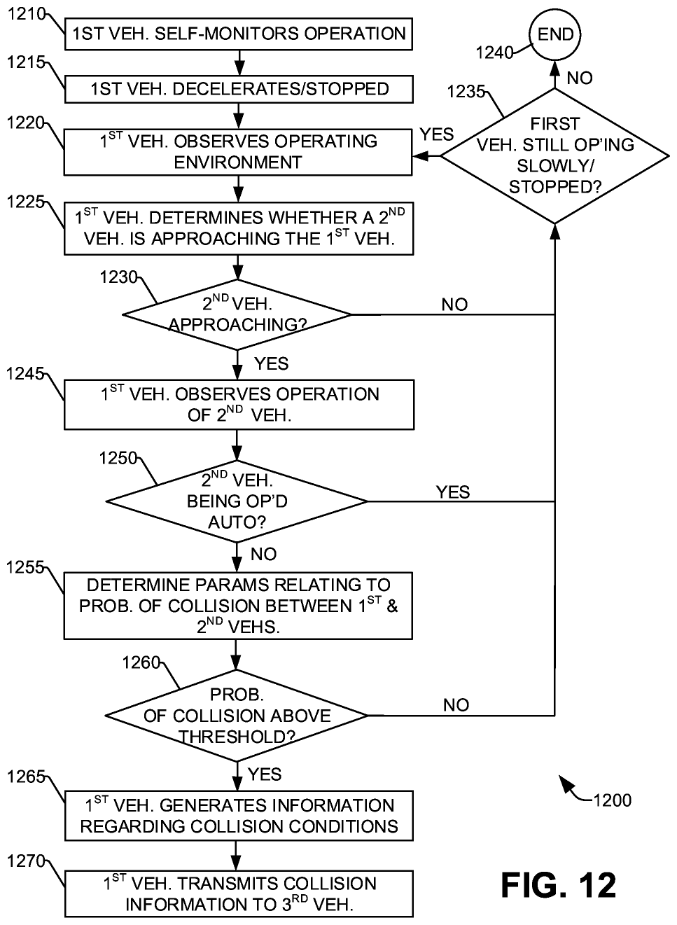

FIG. 12 illustrates a flow diagram 1200 for a computer-implemented methodology for a first vehicle determining operation of a second vehicle to avoid a multi-vehicle collision, in accordance with an embodiment, in accordance with at least one embodiment.

At 1210, a first vehicle (e.g., vehicle 102) is navigating a road (e.g., road 109), while self-monitoring operation via various onboard systems and devices (e.g., cameras/sensors 148A-n, ACS 150, navigation component 141, and suchlike. In an embodiment, the first vehicle can be operating autonomously.

At 1215, the first vehicle can reduce velocity/stop (e.g., via velocity component 145) in response to detecting vehicles (e.g., vehicles 103A-n) stopped/moving slowly ahead (e.g., as detected via vehicle detection component 157, cameras/sensors 148A-n, and suchlike), e.g., due to traffic light, roadworks, etc.

At 1220, the first vehicle can gather information regarding the current location and surroundings of the first vehicle (e.g., via onboard cameras/sensors 148A-n, weather component 175, GPS data/map 188, road component 160 and road data 161, vehicle detection component 157, and suchlike).

At 1225, as part of reviewing the current location and surroundings, the first vehicle can determine (e.g., vehicle detection component 157) whether a second vehicle (e.g., vehicle 106A-n) is approaching the first vehicle (e.g., in direction R, via vehicle detection component 157 and images/data 149A-n, and suchlike).

At 1230, in response to a determination that NO, no vehicle is currently approaching/in the vicinity of the first vehicle, methodology 1200 can advance to 1235. At 1235 a determination (e.g., by AAC 165 in conjunction with velocity component 145) can be made regarding whether the first vehicle is still stopped and/or moving slowly (e.g., in response to traffic lights changing, traffic jam casing). In response to a determination that YES, the first vehicle is still stopped/moving slowly, methodology 1200 can return to 1220 for further monitoring of operation of the first vehicle. At 1235, in response to a determination that NO, the first vehicle is no longer stopped/moving slowly, methodology 1200 can advance to 1240, whereupon the first vehicle can cease monitoring for operation of second vehicle regarding the second vehicle rear-ending the first vehicle.

Returning to 1230, in response to a determination that YES, a second vehicle is approaching the first vehicle (e.g., in direction R), methodology 1200 can advance to 1245, whereupon the first vehicle is configured to monitor operation of the second vehicle. In an embodiment, the first vehicle can be configured to determine (e.g., via vehicle detection component 157) whether the second vehicle is being operated autonomously, partially autonomously, or non-autonomously. As previously described, a driver component (e.g., driver component 156 in conjunction with cameras 148A-n) can be configured to determine whether a driver (e.g., driver 107) is currently operating the second vehicle, e.g., in a partially autonomous or non-autonomous manner. Further, the license plate/model (e.g., license plate 211) can be detected (e.g., via cameras 148A-n and vehicle detection component 157), and a vehicle database (e.g., a vehicle database 180) can be accessed to identify operational data associated with the second vehicle. In an alternative embodiment, the first vehicle can generate and transmit (e.g., vehicle detection component 157, notification 166A-n) an identify request to the first vehicle.

At 1250, per the various detection techniques, in response to a determination of YES, the second vehicle is being operated autonomously, methodology 1200 can return to 1235, where, as previously described, a determination can be made regarding whether the first vehicle is still stationary/slow moving, etc.

At 1250, in response to a determination that NO, the second vehicle is not being operated autonomously, methodology 1200 can advance to 1255. At 1255, various systems onboard the first vehicle can utilized to determine various parameters pertaining to probability of collision (rear-ending) between the second vehicle and the first vehicle. For example, first vehicle can determine (e.g., via road component 160, GPS data/map 188) a current location of the first vehicle, and further, a location C of where a collision (e.g., collision 108) between the second vehicle and first vehicle may occur. The first vehicle can also determine (e.g., via vehicle detection component 157) velocity of the second vehicle (e.g., to determine braking distance BD), a location BP of the second vehicle in the event of an accident, distractedness of the driver (e.g., driver 107) of the second vehicle, road conditions (e.g., in road data 161), weather conditions (e.g., per weather data 176), available braking distance between the first vehicle and the second vehicle (e.g., via braking distance component 152), whether the second vehicle is reducing velocity (e.g., vehicle detection component 157 and braking distance component 152) and suchlike, as previously described.

At 1260, an accident avoidance component (e.g., AAC 165) can be configured to determine a probability of collision between the second vehicle and the first vehicle, per the combination of parameters/variables presented in at least 1255. As previously mentioned, the probabilities of collision can be expressed with arbitrary measures, e.g., imminent, possible, unlikely, zero, e.g., as assessed versus one or more thresholds 167A-n. In response to a determination that probability of collision is zero and/or unlikely, e.g., NO, probability is not above a threshold (e.g., where threshold 167A-n is imminent, possible), methodology 1200 can return to 1235 for further observation of the operating environment. It is to be appreciated that while in a first instant of time, the second vehicle is being operated such that probability of collision is below a threshold, in a second instant of time, the second vehicle may be operated such that probability of collision is above the threshold, whereupon, in such a situation, determination at 1250 would advance to 1255.

At 1260, in response to a determination that probability of collision is imminent and/or possible, e.g., YES, probability is above a threshold (e.g., where threshold 167A-n is imminent, possible), methodology 1265 can advance to 1270.

At 1270, to assist a third vehicle (e.g., vehicle 104) in avoiding a collision with the second vehicle, the first vehicle can generate and transmit pertinent information (e.g., notifications 166A-n, information 198A-n, via communications component 270) relating to the circumstances of potential collision to the third vehicle. The third vehicle can utilize the information to preemptively avoid a collision with the second vehicle.

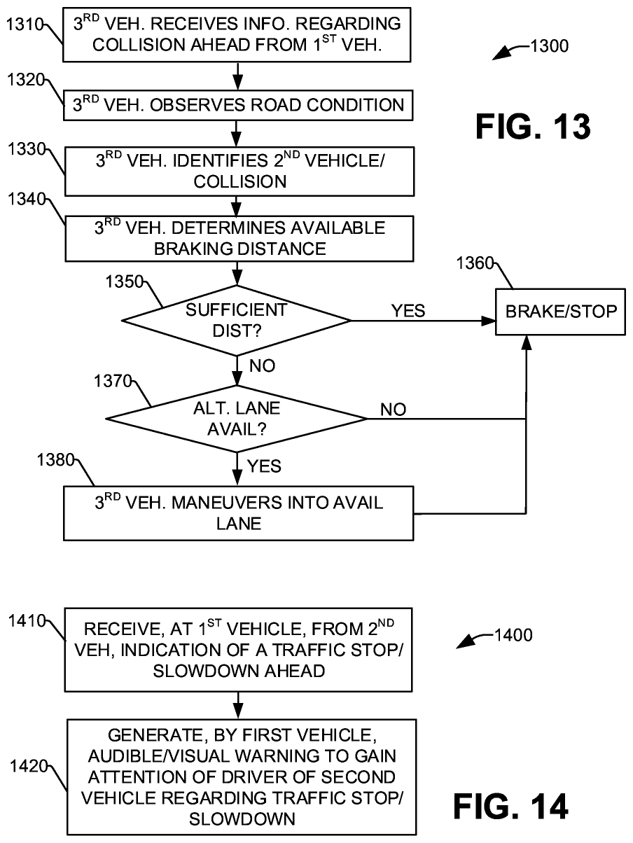

FIG. 13 illustrates a flow diagram 1300 for a computer-implemented methodology for a vehicle to avoid collision with another vehicle to avoid a multi-vehicle collision, in accordance with an embodiment, in accordance with at least one embodiment.

At 1310, information can be received at a vehicle regarding a collision ahead. Respective numbering of vehicles follows the approach utilized in FIG. 12. As mentioned with regard to FIG. 12, a first vehicle (e.g., vehicle 102) can generate and transmit to a third vehicle (e.g., vehicle 104) pertinent information (e.g., notifications 166A-n, information 198A-n) relating to the circumstances of a collision/potential collision between the first vehicle and a second vehicle (e.g., vehicle 106). The received information can include identification information of the second vehicle, location BP of the second vehicle, lane the second vehicle is located in, and suchlike.

At 1320, the third vehicle can observe the conditions of the road (e.g., road 109, e.g., via cameras/sensors 248A-n), weather conditions (e.g., per weather data 275), location of the third vehicle on the road (e.g., via road component 260, road data 261), and suchlike.

At 1330, per the information provided to the third vehicle, e.g., license plate/make/model/colour regarding the second vehicle, the third vehicle can detect (e.g., via cameras/sensors 248A-n, vehicle detection component 263) the second vehicle on the road.

At 1340, the third vehicle can be configured to determine (e.g., AAC 265 in accordance with braking distance component 252, vehicle detection component 263, road component 260, AAC 265, velocity sensors 248A-n, velocity component 245) etc., an available braking distance between the third vehicle and the second vehicle. The third vehicle can take into account such issues as velocity of the third vehicle, road conditions, weather, location of the second vehicle, etc.

At 1350, in response to a determination (e.g., by AAC 265) that YES, there is sufficient distance, between the third vehicle and the second vehicle, for the third vehicle to brake to a stop/slow down without having to change lanes, methodology 1300 can advance to 1360.

At 1360, the third vehicle can be configured to reduce velocity/stop without colliding with the second vehicle. In avoiding collision with the second vehicle, the third vehicle can resume its journey.

Returning to 1350, in response to a determination (e.g., by AAC 265) that NO, there is not sufficient distance, between the third vehicle and the second vehicle, for the third vehicle to brake to a stop/slow down without having to change lanes, methodology 1300 can advance to 1370. At 1370, a further determination can be made (e.g., by AAC 265) regarding whether it is possible for the third vehicle to navigate into an adjacent lane/shoulder (e.g., as identified by road component 260). In response to NO, no adjacent lane is available (e.g., per road data 261), methodology 1300 returns to 1360, whereupon the third vehicle brakes (e.g., via velocity component 245 and AAC 265) while trying to limit effects of a collision with the second vehicle as much as possible.

At 1370, in response to YES, an adjacent lane is available (e.g., per road data 261), methodology 1300 can advance to 1380, whereupon the third vehicle can navigate into the adjacent lane (e.g., L1 to L2) (e.g., via notification 266A-n from AAC 265 to navigation component 241). Methodology 1300 can advance to 1360 where the third vehicle can brake/stop (e.g., via notification 266A-n from AAC 265 to velocity component 245). In avoiding collision with the second vehicle, the third vehicle can resume its journey.

FIG. 14 illustrates a flow diagram 1400 for a computer-implemented methodology for a vehicle to activate various warnings to prevent another vehicle being involved in a multi-vehicle collision, in accordance with an embodiment, in accordance with at least one embodiment.

At 1410, a first vehicle can be configured to determine an accident has happened, or has the potential to happen, and in an attempt to mitigate escalation of the accident from a rear-end collision between two vehicles to becoming a multi-vehicle pile-up, the first vehicle can activate various warnings to alert other drivers/vehicles. In an embodiment, the first vehicle (e.g., vehicle 104) can receive an indication (e.g., a notification 166A-n in information 198A-n) that an accident has occurred/may occur on the road (e.g., road 109), wherein the first vehicle can receive the indication from a second vehicle (e.g., vehicle 102). In another embodiment, the indication can be received at the first vehicle from a remote system, e.g., system 199, wherein system 199 is configured to transmit accident information to vehicles in the vicinity of the accident configured to receive the indication from the remote system.

At 1420, in response to receiving the indication of an accident ahead, the first vehicle can be configured to detect (e.g., via vehicle detection component 263) presence of a third vehicle (e.g., vehicle 106). In response to detecting presence of the third vehicle, the first vehicle can activate (e.g., via a notification 166A-n from AAC 265/warning component 268 to devices component 246) operation of at least one of an audible horn, hazard lights, etc., in an attempt to obtain the attention of a driver (e.g., driver 107) of the third vehicle, and accordingly, reduce the probability of the third vehicle colliding with the first vehicle.

### Example Applications and Use

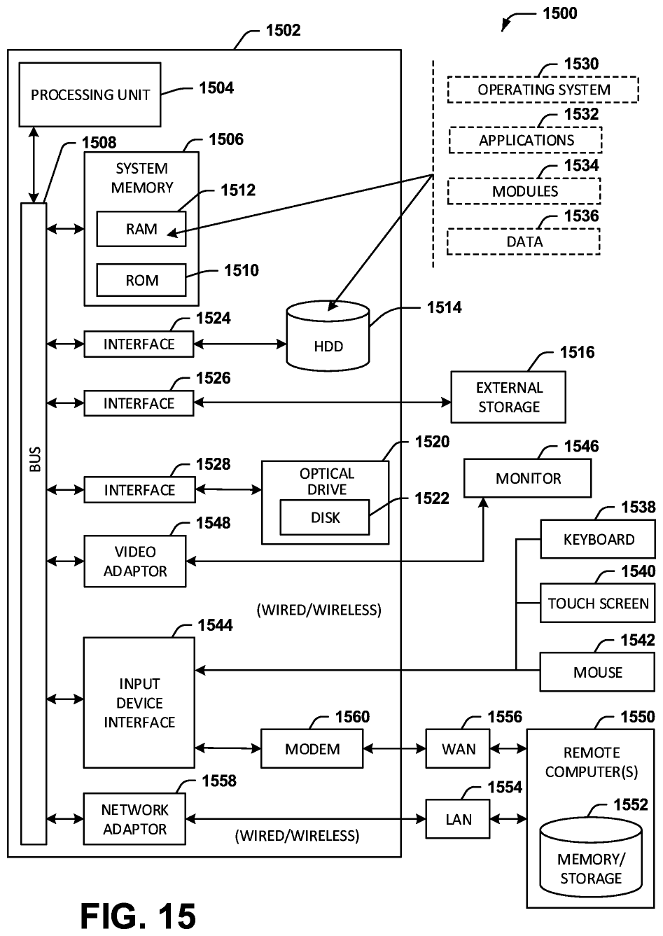

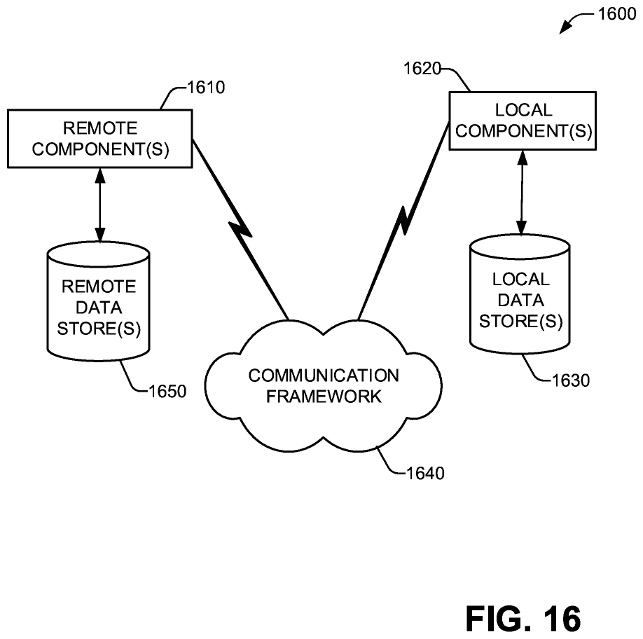

Turning next to FIGS. 15 and 16, a detailed description is provided of additional context for the one or more embodiments described herein with FIGS. 1-14 and 17.

In order to provide additional context for various embodiments described herein, FIG. 15 and the following discussion are intended to provide a brief, general description of a suitable computing environment 1500 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 15, the example environment 1500 for implementing various embodiments of the aspects described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors and may include a cache memory. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), one or more external storage devices 1516 (e.g., a magnetic floppy disk drive (FDD) 1516, a memory stick or flash drive reader, a memory card reader, etc.) and an optical disk drive 1520 (e.g., which can read or write from a CD-ROM disc, a DVD, a BD, etc.). While the internal HDD 1514 is illustrated as located within the computer 1502, the internal HDD 1514 can also be configured for external use in a suitable chassis (not shown). Additionally, while not shown in environment 1500, a solid-state drive (SSD) could be used in addition to, or in place of, an HDD 1514. The HDD 1514, external storage device(s) 1516 and optical disk drive 1520 can be connected to the system bus 1508 by an HDD interface 1524, an external storage interface 1526 and an optical drive interface 1528, respectively. The interface 1524 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application.

Further, computer 1502 can comprise a security module, such as a trusted processing module (TPM). For instance with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1094 serial port, a game port, a USB port, an IR interface, a BLUETOOTH® interface, etc.

A monitor 1546 or other type of display device can be also connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired and/or wireless communications to one or more remote computers, such as a remote computer(s) 1550. The remote computer(s) 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 and/or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the internet.

When used in a LAN networking environment, the computer 1502 can be connected to the local network 1554 through a wired and/or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. It will be appreciated that the network connections shown are example and other means of establishing a communications link between the computers can be used.

When used in either a LAN or WAN networking environment, the computer 1502 can access cloud storage systems or other network-based storage systems in addition to, or in place of, external storage devices 1516 as described above. Generally, a connection between the computer 1502 and a cloud storage system can be established over a LAN 1554 or WAN 1556 e.g., by the adapter 1558 or modem 1560, respectively. Upon connecting the computer 1502 to an associated cloud storage system, the external storage interface 1526 can, with the aid of the adapter 1558 and/or modem 1560, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

Referring now to details of one or more elements illustrated at FIG. 16, an illustrative cloud computing environment 1600 is depicted. FIG. 16 is a schematic block diagram of a computing environment 1600 with which the disclosed subject matter can interact. The system 1600 comprises one or more remote component(s) 1610. The remote component(s) 1610 can be hardware and/or software (e.g., threads, processes, computing devices). In some embodiments, remote component(s) 1610 can be a distributed computer system, connected to a local automatic scaling component and/or programs that use the resources of a distributed computer system, via communication framework 1640. Communication framework 1640 can comprise wired network devices, wireless network devices, mobile devices, wearable devices, radio access network devices, gateway devices, femtocell devices, servers, etc.

The system 1600 also comprises one or more local component(s) 1620. The local component(s) 1620 can be hardware and/or software (e.g., threads, processes, computing devices). In some embodiments, local component(s) 1620 can comprise an automatic scaling component and/or programs that communicate/use the remote resources 1610 and 1620, etc., connected to a remotely located distributed computing system via communication framework 1640.

One possible communication between a remote component(s) 1610 and a local component(s) 1620 can be in the form of a data packet adapted to be transmitted between two or more computer processes. Another possible communication between a remote component(s) 1610 and a local component(s) 1620 can be in the form of circuit-switched data adapted to be transmitted between two or more computer processes in radio time slots. The system 1600 comprises a communication framework 1640 that can be employed to facilitate communications between the remote component(s) 1610 and the local component(s) 1620, and can comprise an air interface, e.g., Uu interface of a UMTS network, via a long-term evolution (LTE) network, etc. Remote component(s) 1610 can be operably connected to one or more remote data store(s) 1650, such as a hard drive, solid state drive, SIM card, device memory, etc., that can be employed to store information on the remote component(s) 1610 side of communication framework 1640. Similarly, local component(s) 1620 can be operably connected to one or more local data store(s) 1630, that can be employed to store information on the local component(s) 1620 side of communication framework 1640.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

The description of illustrated embodiments of the subject disclosure as provided herein, including what is described in the Background, Summary, Detailed Description, and Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Various non-limiting aspects of various embodiments described herein are presented in the following clauses:
Clause 1: A system, located on a first vehicle navigating a road, comprising a memory that stores computer executable components, and a processor that executes the computer executable components stored in the memory, wherein the computer executable components comprise: an accident avoidance component configured to adjust operation of the first vehicle based on a notification received from a second vehicle, wherein the notification indicates a collision present in the road being navigated by the first vehicle.
Clause 2: The system of any preceding clause, wherein the collision involves the second vehicle and a third vehicle.
Clause 3: The system of any preceding clause, wherein the second vehicle was operating autonomously at the time the collision occurred.
Clause 4: The system of any preceding clause, wherein the notification further comprises information regarding the third vehicle.
Clause 5: The system of any preceding clause, further comprising: a camera configured to generate an image of the road being navigated by the first vehicle, and a vehicle detection component configured to detect the third vehicle, wherein detection of the third vehicle is based at least in part on identification of the third vehicle in the image, wherein the identification is based at least in part on the third vehicle information in the notification.
Clause 6: The system of any preceding clause, wherein the notification indicates location of the third vehicle.
Clause 7: The system of any preceding clause, further comprising a braking distance component configured to: determine a braking distance required for the first vehicle to stop, determine an available breaking distance, wherein the available braking distance is a distance from a current location of the first vehicle to the location of the third vehicle, and determine whether the braking distance required for the first vehicle to stop is less than the available braking distance.
Clause 8: The system of any preceding clause, wherein the braking distance component further configured to: in the event of the braking distance required for the first vehicle to stop is less than the available braking distance, generate and transmit a second notification to the accident avoidance component indicating the first vehicle has sufficient distance to stop and avoid collision with the third vehicle, and wherein the accident avoidance component is further configured to, in response to receiving the second notification, reduce an operational velocity of the first vehicle.
Clause 9: The system of any preceding clause, wherein the braking distance component further configured to: in the event of the braking distance required for the first vehicle to stop is greater than the available braking distance, generate and transmit a third notification to the accident avoidance component indicating there is insufficient available braking distance for the first vehicle to avoid collision with the third vehicle, wherein the first vehicle and second vehicle are operating in a first lane of the road, and wherein the accident avoidance component is further configured to: in response to receiving third notification, determine, whether there is an adjacent lane to the first lane of the road, and in response to determining an adjacent lane is available, maneuver the first vehicle into the adjacent lane.
Clause 10: The system of any preceding clause, further comprising a road condition component configured to adjust the braking distance required for the first vehicle to stop as a function of at least one of weather condition or road condition.
Clause 11: The system of any preceding clause, wherein the first vehicle is operating at least partially autonomously while navigating the road.
Clause 12: A computer-implemented method comprising: adjusting, by a device comprising a processor located on a first vehicle operating in at least a partially autonomous manner, operation of the first vehicle based on a notification received from a second vehicle, wherein the notification indicates a collision present on a road being navigated by the first vehicle.
Clause 13: The computer-implemented method of any preceding clause, wherein the collision involves the second vehicle and a third vehicle, and the notification further indicates current location of the third vehicle.
Clause 14: The computer-implemented method of any preceding clause, further comprising: determining, by the device, a braking distance required for the first vehicle to stop; determining, by the device, an available breaking distance, wherein the available braking distance is a distance from the current location of the first vehicle to the location of the third vehicle; and determining, by the device, whether the braking distance required for the first vehicle to stop is less than the available braking distance.
Clause 15: The computer-implemented method of any preceding clause, further comprising in the event of the braking distance required for the first vehicle to stop is less than the available braking distance, reducing, by the device, an operational velocity of the first vehicle.
Clause 16: The computer-implemented method of any preceding clause, further comprising in the event of the braking distance required for the first vehicle to stop is greater than the available braking distance, determining, by the device, whether there is an adjacent lane to the first lane of the road, and in response to determining an adjacent lane is available, navigating, by the device, the first vehicle into the adjacent lane.
Clause 17: A computer program product comprising a computer readable storage medium having program instructions embodied therewith, the program instructions executable by a processor located on a first vehicle, to cause the processor to: adjust operation of the first vehicle based on a notification received from a second vehicle, wherein the notification indicates a collision present on a road being navigated by the first vehicle, the collision involves the second vehicle and a third vehicle, and the notification further indicates current location of the third vehicle.
Clause 18: The computer program product of any preceding clause, wherein the program instructions are further executable by the processor to cause the processor to: determine a braking distance required for the first vehicle to stop, determine an available breaking distance, wherein the available braking distance is a distance from the current location of the first vehicle to the location of the third vehicle, and determine whether the braking distance required for the first vehicle to stop is less than the available braking distance.
Clause 19: The computer program product of any preceding clause, wherein the program instructions are further executable by the processor to cause the processor to, in the event of the braking distance required for the first vehicle to stop is less than the available braking distance, reduce an operational velocity of the first vehicle.
Clause 20: The computer program product of any preceding clause, wherein the program instructions are further executable by the processor to cause the processor to, in the event of the braking distance required for the first vehicle to stop is greater than the available braking distance, determine whether there is an adjacent lane to the first lane of the road, and in response to determining an adjacent lane is available, navigate the first vehicle into the adjacent lane.

In various cases, any suitable combination of clauses 1-11 can be implemented.

In various cases, any suitable combination of clauses 12-16 can be implemented.

In various cases, any suitable combination of clauses 17-20 can be implemented.

What is claimed is:

1. A system, located on a first vehicle navigating a road, comprising:
a memory that stores computer executable components; and
a processor that executes the computer executable components stored in the memory, wherein the computer executable components comprise:
an accident avoidance component configured to adjust operation of the first vehicle based on a notification received from a second vehicle, wherein the notification indicates a collision present in the road being navigated by the first vehicle.

2. The system of claim 1, wherein the collision involves the second vehicle and a third vehicle.

3. The system of claim 2, wherein the second vehicle was operating autonomously at the time the collision occurred.

4. The system of claim 2, wherein the notification further comprises information regarding the third vehicle.

5. The system of claim 4, further comprising:
a camera configured to generate an image of the road being navigated by the first vehicle; and
a vehicle detection component configured to:
detect the third vehicle, wherein detection of the third vehicle is based at least in part on identification of the third vehicle in the image, wherein the identification is based at least in part on the third vehicle information in the notification.

6. The system of claim 1, wherein the notification indicates location of the third vehicle.

7. The system of claim 6, further comprising a braking distance component configured to:
determine a braking distance required for the first vehicle to stop;
determine an available breaking distance, wherein the available braking distance is a distance from a current location of the first vehicle to the location of the third vehicle; and
determine whether the braking distance required for the first vehicle to stop is less than the available braking distance.

8. The system of claim 7, wherein the braking distance component further configured to:
in the event of the braking distance required for the first vehicle to stop is less than the available braking distance, generate and transmit a second notification to the accident avoidance component indicating the first vehicle has sufficient distance to stop and avoid collision with the third vehicle; and
wherein the accident avoidance component is further configured to, in response to receiving the second notification, reduce an operational velocity of the first vehicle.

9. The system of claim 8, wherein the braking distance component further configured to:
in the event of the braking distance required for the first vehicle to stop is greater than the available braking distance, generate and transmit a third notification to the accident avoidance component indicating there is insufficient available braking distance for the first vehicle to avoid collision with the third vehicle, wherein the first vehicle and second vehicle are operating in a first lane of the road; and
wherein the accident avoidance component is further configured to:
in response to receiving third notification, determine, whether there is an adjacent lane to the first lane of the road; and
in response to determining an adjacent lane is available, maneuver the first vehicle into the adjacent lane.

10. The system of claim 8, further comprising a road condition component configured to adjust the braking distance required for the first vehicle to stop as a function of at least one of weather condition or road condition.

11. The system of claim 1, wherein the first vehicle is operating at least partially autonomously while navigating the road.

12. A computer-implemented method comprising:
adjusting, by a device comprising a processor located on a first vehicle operating in at least a partially autonomous manner, operation of the first vehicle based on a notification received from a second vehicle, wherein the notification indicates a collision present on a road being navigated by the first vehicle.

13. The computer-implemented method of claim 12, wherein the collision involves the second vehicle and a third vehicle, and the notification further indicates current location of the third vehicle.

14. The computer-implemented method of claim 13, further comprising:
determining, by the device, a braking distance required for the first vehicle to stop;
determining, by the device, an available breaking distance, wherein the available braking distance is a distance from the current location of the first vehicle to the location of the third vehicle; and
determining, by the device, whether the braking distance required for the first vehicle to stop is less than the available braking distance.

15. The computer-implemented method of claim 14, further comprising:
in the event of the braking distance required for the first vehicle to stop is less than the available braking distance, reducing, by the device, an operational velocity of the first vehicle.

16. The computer-implemented method of claim 14, further comprising:
in the event of the braking distance required for the first vehicle to stop is greater than the available braking distance, determining, by the device, whether there is an adjacent lane to the first lane of the road; and
in response to determining an adjacent lane is available, navigating, by the device, the first vehicle into the adjacent lane.

17. A computer program product comprising a computer readable storage medium having program instructions embodied therewith, the program instructions executable by a processor located on a first vehicle, to cause the processor to:
adjust operation of the first vehicle based on a notification received from a second vehicle, wherein the notification indicates a collision present on a road being navigated by the first vehicle, the collision involves the second vehicle and a third vehicle, and the notification further indicates current location of the third vehicle.

18. The computer program product of claim 17, wherein the program instructions are further executable by the processor to cause the processor to:
determine a braking distance required for the first vehicle to stop;
determine an available breaking distance, wherein the available braking distance is a distance from the current location of the first vehicle to the location of the third vehicle; and
determine whether the braking distance required for the first vehicle to stop is less than the available braking distance.

19. The computer program product of claim 18, wherein the program instructions are further executable by the processor to cause the processor to:
in the event of the braking distance required for the first vehicle to stop is less than the available braking distance, reduce an operational velocity of the first vehicle.

20. The computer program product of claim 18, wherein the program instructions are further executable by the processor to cause the processor to:
in the event of the braking distance required for the first vehicle to stop is greater than the available braking distance, determine whether there is an adjacent lane to the first lane of the road; and
in response to determining an adjacent lane is available, navigate the first vehicle into the adjacent lane.
